(19) United States
(12) Patent Application Publication
(10) Pub. No.: US 2026/0225560 A1
(43) Pub. Date: Aug. 6, 2026

(54) LENS CLEANING METHOD FOR LAWN MOWER

(71) Applicant: Nexlawn Intelligent Technology (Suzhou) Co., Ltd., Suzhou (CN)

(72) Inventors: Fei LI, Suzhou (CN); Pengyu WANG, Suzhou (CN); Yao YAO, Suzhou (CN)

(21) Appl. No.: 19/632,147

(22) Filed: Mar. 27, 2026

Related U.S. Application Data
(63) Continuation-in-part of application No. 19/030,983, filed on Jan. 17, 2025, now abandoned.
Application No. 19/030,983 is a continuation of application No. PCT/CN2023/107420, filed on Jul. 14, 2023.

(30) Foreign Application Priority Data
Jul. 22, 2022 (CN) 202221904438.9
Jul. 22, 2022 (CN) 202221928660.2

(51) Int. Cl. B60S 1/08; A01D 34/00; B60S 1/56; A01D 101/00

(52) U.S. Cl. CPC B60S 1/0896; A01D 34/008; B60S 1/0822; B60S 1/56; A01D 2101/00; B60Y 2200/22

(57) ABSTRACT

A lens cleaning method for a lawn mower is provided. The lawn mower includes a vision assembly, a drive assembly and a cleaning assembly; the vision assembly includes a lens body; a cleaning member is provided on a side of the cleaning assembly facing the lens body; the drive assembly is connected to the cleaning member and is configured to drive the cleaning member to move relative to the lens body for cleaning the lens body; the above lens cleaning method includes: when both the lawn mower and the lens body are activated, acquiring a working state of the lawn mower and a position of the lawn mower relative to a charging station, and determining whether to control the drive assembly to drive the cleaning member to move relative to the lens body for cleaning the lens body.

### CROSS-REFERENCE TO RELATED APPLICATIONS

This application is a continuation-in-part of U.S. Application No. 19/030,983, filed on January 17, 2025, which is a continuation of International Application No. PCT/CN2023/107420, filed on July 14, 2023. The International Application claims the priority to Chinese Patent Application No. 202221904438.9 filed on July 22, 2022 and Chinese Patent Application No. 202221928660.2 filed on July 22, 2022. The disclosures of the aforementioned applications are hereby incorporated by reference in their entireties.

### TECHNICAL FIELD

The present application relates to the control field of lawn mowers and, in particular, to a lens cleaning method for a lawn mower.

### BACKGROUND

With the unceasing improvement in living conditions and scientific and technological levels, lawn mowers become convenient to use with desirable cleaning effects. Thus, the lawn mowers have gradually replaced manual workers for weeding in life and work. With growing popularity, the lawn mowers with a single weeding function are far from satisfying the demand from users. Some intelligent lawn mowers even can automatically weed plants with camera devices.

At present, the lawn mower with the camera device cannot clean the camera device, and functions of the camera device will be affected dramatically once they are covered with debris such as grass clippings and dirt.

In view of that, it is necessary to overcome the defects in the prior art by improving the prior art.

With the gradual popularization of lawn mowers, more and more users have become accustomed to using intelligent lawn mowers.

Lawn mowers equipped with visual recognition functions available on the market can collect images or videos of the surrounding environment through a lens body, so as to provide visual data support for intelligent operations such as obstacle avoidance and path planning of the lawn mowers. However, for such intelligent lawn mowers equipped with the lens body on the body, the lens of the lens body is easily adhered with debris such as grass clippings, dust and dirt generated during operation, resulting in blurred imaging or even failure of the lens. This directly affects the environmental perception capability of the lens body, thereby leading to a significant decrease in the operational stability of functions such as obstacle avoidance and path planning. Under normal circumstances, such lawn mowers require users to wipe the lens frequently, which reduces the intelligent level of the lawn mowers and affects the user experience.

### SUMMARY

An embodiment of the present application provides a lens cleaning method for a lawn mower, so as to automatically clean the lens body mounted on the lawn mower and ensure the effectiveness of the environmental perception capability of the lens body.

In a first aspect, an embodiment of the present application provides a lens cleaning method for a lawn mower, where the lawn mower includes a vision assembly, a drive assembly and a cleaning assembly; the vision assembly includes a lens body; a cleaning member is provided on a side of the cleaning assembly facing the lens body; the drive assembly is connected to the cleaning member and is configured to drive the cleaning member to move relative to the lens body for cleaning the lens body; the method includes: when both the lawn mower and the lens body are activated, acquiring a working state of the lawn mower and a position of the lawn mower relative to a charging station, and determining whether to control the drive assembly to drive the cleaning member to move relative to the lens body for cleaning the lens body; the working state includes a trigger instruction receiving state, a triggered state and a standby state; where the triggered state is a state of performing a work task corresponding to a trigger instruction; the standby state is a state in which the lawn mower is activated and does not receive the trigger instruction, or in which the lawn mower has completed a previous work task and does not receive a new trigger instruction; the position of the lawn mower relative to the charging station includes that the lawn mower is located inside the charging station or outside the charging station.

In a possible implementation, the acquiring the working state of the lawn mower and the position of the lawn mower relative to the charging station, and determining whether to control the drive assembly to drive the cleaning member to move relative to the lens body for cleaning the lens body, includes: when the lawn mower is in the trigger instruction receiving state and is located outside the charging station, controlling the drive assembly to drive the cleaning member to move relative to the lens body for cleaning the lens body; after surface cleaning of the lens body is completed, controlling the lawn mower to perform the work task; when the lawn mower is in the trigger instruction receiving state and is located inside the charging station, controlling the lawn mower to move away from the charging station for outgoing until the lawn mower is located outside the charging station, controlling the lawn mower to stop moving, and controlling the drive assembly to drive the cleaning member to move relative to the lens body for cleaning the lens body; after the surface cleaning of the lens body is completed, controlling the lawn mower to perform the work task; when the lawn mower is in the standby state and is located outside the charging station, controlling the drive assembly to drive the cleaning member to move relative to the lens body for cleaning the lens body; when the lawn mower is in the standby state and is located inside the charging station, controlling the cleaning assembly not to perform cleaning.

In a possible implementation, the acquiring the working state of the lawn mower and the position of the lawn mower relative to the charging station, and determining whether to control the drive assembly to drive the cleaning member to move relative to the lens body for cleaning the lens body, further includes: when the lawn mower is in the triggered state, controlling the drive assembly to drive the cleaning member to move relative to the lens body for cleaning the lens body at a preset frequency.

In a second aspect, an embodiment of the present application provides a lens cleaning method for a lawn mower, where the lawn mower includes a vision assembly, a drive assembly, a cleaning assembly and a contamination detection assembly; the vision assembly includes a lens body; a cleaning member is provided on a side of the cleaning assembly facing the lens body; the drive assembly is connected to the cleaning member and is configured to drive the cleaning member to move relative to the lens body for cleaning the lens body; the contamination detection assembly is in communication connection with the lens body and is configured to detect a contamination condition on a surface of the lens body when the lens body is activated; the method includes: when both the lawn mower and the lens body are activated, and when the contamination detection assembly detects that contamination exists on the surface of the lens body, acquiring a working state of the lawn mower and a position of the lawn mower relative to a charging station, and determining whether to control the drive assembly to drive the cleaning member to move relative to the lens body for cleaning the lens body; the working state includes a trigger instruction receiving state, a triggered state and a standby state; where the triggered state is a state of performing a return-to-charge task, a map construction task or a mowing task corresponding to a trigger instruction; the standby state is a state in which the lawn mower is activated and does not receive the trigger instruction, or in which the lawn mower has completed a previous work task and does not receive receiving a new trigger instruction; the position of the lawn mower relative to the charging station includes that the lawn mower is located inside the charging station or outside the charging station.

In a possible implementation, the when the contamination detection assembly detects that the contamination exists on the surface of the lens body, acquiring the working state of the lawn mower and the position of the lawn mower relative to the charging station, and determining whether to control the drive assembly to drive the cleaning member to move relative to the lens body for cleaning the lens body, includes: when the lawn mower is in the trigger instruction receiving state, if the contamination detection assembly detects that the contamination exists on the surface of the lens, acquiring the position of the lawn mower relative to the charging station, and controlling the drive assembly to drive the cleaning member to move relative to the lens body for cleaning the surface of the lens body.

In a possible implementation, the acquiring the position of the lawn mower relative to the charging station, and controlling the drive assembly to drive the cleaning member to move relative to the lens body for cleaning the surface of the lens body, includes: if the lawn mower is located outside the charging station, controlling the drive assembly to drive the cleaning member to move relative to the lens body for cleaning the lens body; after surface cleaning of the lens body is completed, controlling the lawn mower to perform the return-to-charge task, the map construction task or the mowing task; if the lawn mower is located inside the charging station and the trigger instruction is the map construction task or the mowing task, controlling the lawn mower to move away from the charging station for outgoing until the lawn mower is located outside the charging station, controlling the lawn mower to stop moving, and controlling the drive assembly to drive the cleaning member to move relative to the lens body for cleaning the lens body; after the surface cleaning of the lens body is completed, controlling the lawn mower to perform the map construction task or the mowing task.

In a possible implementation, the method further includes: during that the lawn mower performs the map construction task or the mowing task, if the contamination detection assembly detects that the contamination does not exists on the surface of the lens body, controlling the lawn mower to move at an initial moving speed; if the contamination detection assembly detects that the contamination exists on the surface of the lens body, controlling the drive assembly to drive the cleaning member to move relative to the lens body, and during the moving of the cleaning member, controlling the lawn mower to move at a preset moving speed; the preset moving speed is lower than the initial moving speed.

In a possible implementation, the method further includes: during that the lawn mower performs the return-to-charge task, controlling the lawn mower to move along a return-to-charge path corresponding to the return-to-charge task for performing the return-to-charge task.

In a possible implementation, the method further includes: during the moving of the lawn mower along the return-to-charge path, if the contamination detection assembly detects that the contamination exists on the surface of the lens body, controlling the lawn mower to move to a preset position and stop moving; the preset position is on the return-to-charge path; controlling the drive assembly to drive the cleaning member to move relative to the lens body for cleaning the lens body; after the surface cleaning of the lens body is completed, controlling the lawn mower to continue moving along the return-to-charge path so as to continue performing the return-to-charge task.

In a possible implementation, where the when the contamination detection assembly detects that the contamination exists on the surface of the lens body, acquiring the working state of the lawn mower and the position of the lawn mower relative to the charging station, and determining whether to control the drive assembly to drive the cleaning member to move relative to the lens body for cleaning the lens body, includes: when the lawn mower is in the standby state, and when the contamination detection assembly detects that the contamination exists on the surface of the lens body, determining whether to control the drive assembly to drive the cleaning member to move relative to the lens body for cleaning the surface of the lens body based on the position of the lawn mower relative to the charging station.

In a possible implementation, the determining whether to control the drive assembly to drive the cleaning member to move relative to the lens body for cleaning the surface of the lens body based on the position of the lawn mower relative to the charging station, includes: if the lawn mower is located outside the charging station, controlling the drive assembly to drive the cleaning member to move relative to the lens body for cleaning the lens body; if the lawn mower is located inside the charging station, not performing automatic cleaning of the lens body.

In a possible implementation, after the determining to control the drive assembly to drive the cleaning member to move relative to the lens body for cleaning the lens body, the method further includes: when the contamination detection assembly detects that the contamination still exists on the surface of the lens body, controlling the cleaning member to move relative to the lens body for a preset time duration; and when the contamination still exists on the surface of the lens body, deactivating the lens body or controlling the lens body to stop outputting detection results, controlling the cleaning member to reset, and controlling the lawn mower to continue working.

In a possible implementation, after deactivating the lens body, the method further includes: generating prompt information to prompt a user that the contamination detection assembly of the lawn mower is abnormal or the cleaning member is not capable of completing automatic cleaning of the lens body.

In a possible implementation, when controlling the cleaning member to move relative to the lens body for cleaning the lens body, the method includes: when the lawn mower needs to perform obstacle avoidance, performing an obstacle avoidance task synchronously during the controlling of the cleaning member to move relative to the lens body.

In a possible implementation, when controlling the cleaning member to move relative to the lens body for cleaning the lens body, the method includes: controlling the cleaning member to move relative to the lens body for a preset number of times at a preset cleaning cycle; the preset cleaning cycle includes an operation time period and a stop time period, the stop time period is set according to a preset duration, and the operation time period is shorter than the stop time period.

In a possible implementation, the method further includes: during the moving of the cleaning member relative to the lens body, deactivating the lens body or stopping outputting detection results.

In view of that, the disclosure aims at solving the technical problem that a self-propelled apparatus with a camera device cannot clean the camera device in the prior art.

To solve the technical problem described above, some embodiments of the disclosure provide a lens cleaning device for a self-propelled apparatus. The lens cleaning device for a self-propelled apparatus includes: a mounting frame; and a cleaning assembly, where the cleaning assembly is movably connected to the mounting frame, an end, far away from the mounting frame, of the cleaning assembly is provided with a cleaning member, and in a case that the cleaning member is pressed by pressing external force, at least the cleaning member moves relative to the mounting frame.

In some embodiments, the cleaning assembly includes: a connection portion, where the connection portion is connected to the mounting frame; and a cleaning portion, where one end of the cleaning portion is connected to the connection portion, and the other end of cleaning portion is provided with the cleaning member.

In some embodiments, the connection portion includes a connection shaft, the connection shaft is pivotally connected to the mounting frame, and the cleaning portion is connected to the connection shaft.

In some embodiments, the connection portion further includes a resetting member, and the resetting member at least abuts between the cleaning portion and the mounting frame, to provide resetting force for the cleaning portion.

In some embodiments, the cleaning portion includes a first section and a second section that are connected in sequence, an end, far away from the second section, of the first section is connected to the connection shaft, the second section is provided with the cleaning member, and the first section is arranged at an angle relative to the second section.

In some embodiments, an included angle between the first section and the second section is greater than 90 degrees; the second section is provided with the cleaning member on a surface of an area where the first section and the second section form the included angle; an included angle between the second section and a vertical direction is greater than 0 degree and less than or equal to 45 degrees; and the first section extends in the vertical direction.

In some embodiments, the cleaning assembly includes: a drive portion, where the drive portion is in driving connection to the cleaning member and drives the cleaning member to rotate; and a detection portion, where the detection portion is connected to the drive portion.

In some embodiments, the cleaning assembly includes: a water storage tank, where the water storage tank is arranged on the mounting frame; the cleaning member is a cleaning cloth, and a cleaning liquid is contained in the water storage tank; and one end of the cleaning cloth is arranged on the water storage tank and soaked in the cleaning liquid, and the other end of the cleaning cloth is suspended below the water storage tank under the action of gravity.

In some embodiments, a length and/or a width of the cleaning member are/is greater than a diameter of a lens.

In some embodiments, the mounting frame includes a support section and a connection section that are connected in sequence; the connection section is located above the support section, and the support section extends in the vertical direction; and an included angle is formed between the connection section and a horizontal direction, and the cleaning assembly is connected to the connection section and is suspended below the connection section.

The disclosure further provides a charging station for a self-propelled apparatus. The charging station for a self-propelled apparatus includes: a charging station body; and the lens cleaning device for a self-propelled apparatus described above, where the charging station body is arranged on a mounting frame of the lens cleaning device for a self-propelled apparatus.

A technical solution according to the disclosure has the follow advantages: The lens cleaning device for a self-propelled apparatus in the disclosure includes the mounting frame and the cleaning assembly. The cleaning assembly is movably connected to the mounting frame, the end, far away from the mounting frame, of the cleaning assembly is provided with the cleaning member, and in a case that the cleaning member is pressed by pressing external force, at least the cleaning member moves relative to the mounting frame.

It can be seen from the contents described above that when the lens cleaning device for a self-propelled apparatus in the disclosure is used, in a case that the self-propelled apparatus is parked below the mounting frame, the self-propelled apparatus can press against the mounting frame or a camera device of the self-propelled apparatus can come into contact with the cleaning member during movement, such that the cleaning member can clean the camera device of the self-propelled apparatus. Thus, the lens cleaning device for a self-propelled apparatus in the disclosure effectively solves the problem that the self-propelled apparatus with the camera device cannot clean the camera device in the prior art.

With the unceasing improvement in living conditions and scientific and technological levels, lawn mowers become convenient to use with desirable cleaning effects. Thus, the lawn mowers have gradually replaced manual workers for weeding in life and work. With growing popularity, the lawn mowers with a single weeding function are far from satisfying the demand from users. Some intelligent lawn mowers even can automatically weed plants with camera devices.

At present, the lawn mower with the camera device cannot clean the camera device, and functions of the camera device will be affected dramatically once they are covered with debris such as grass clippings and dirt.

In view of that, it is necessary to overcome the defects in the prior art by improving the prior art.

In view of that, the disclosure aims at solving the technical problem that the self-propelled apparatus with the camera device cannot clean the camera device in the prior art.

To solve the technical problem described above, the disclosure provides an automatic lens cleaning device. The automatic lens cleaning device includes: a lens body; a drive assembly; and a cleaning assembly, where at least part of the cleaning assembly is arranged in a circumferential direction of the lens body, a side, facing the lens body, of the at least part of the cleaning assembly is provided with a cleaning member, the drive assembly is in driving connection to the cleaning assembly to cause at least the cleaning member of the cleaning assembly to move relative to the lens body, and the cleaning member of the cleaning assembly cleans a lens surface of the lens body.

In some embodiments, the automatic lens cleaning device further includes a mounting seat, where the lens body and the cleaning assembly are arranged on the mounting seat.

In some embodiments, the cleaning assembly is movably arranged on the mounting seat, the drive assembly drives the cleaning assembly to move along a preset path, and in a case that the cleaning assembly moves along the preset path, at least part of the cleaning assembly comes into contact with different positions of the lens body.

In some embodiments, two ends of the cleaning assembly are slidably connected to the mounting seat, to cause the drive assembly to drive the cleaning assembly to slide relative to the mounting seat.

In some embodiments, two ends of the cleaning assembly are connected to the mounting seat, and the drive assembly drives the cleaning assembly to rotate relative to the mounting seat.

In some embodiments, a connection line of the two ends, connected to the mounting seat, of the cleaning assembly passes through a circle center of the lens body.

In some embodiments, a rotation angle of the cleaning assembly is greater than or equal to 120 degrees.

In some embodiments, a distance between an end, close to the lens body, of the cleaning member and the lens body is less than or equal to 5 mm.

In some embodiments, the cleaning assembly further includes a base portion, two ends of the base portion are rotatably connected to the mounting seat, and the cleaning member is arranged at a side, facing the lens body, of the base portion and extends towards the lens body.

In some embodiments, a surface of the side, on which the cleaning member is mounted, of the base portion is a camber, and a diameter of the camber is greater than a diameter of the lens body.

The disclosure further provides a self-propelled apparatus. The self-propelled apparatus includes the automatic lens cleaning device described above.

A technical solution according to the disclosure has the follow advantages: The automatic lens cleaning device in the disclosure includes the lens body, the drive assembly, and the cleaning assembly. The at least part of the cleaning assembly is arranged in the circumferential direction of the lens body, the side, facing the lens body, of the at least part of the cleaning assembly is provided with the cleaning member, the drive assembly is in driving connection to the cleaning assembly to cause at least the cleaning member of the cleaning assembly to move relative to the lens body, and the cleaning member of the cleaning assembly cleans the lens surface of the lens body.

It can be seen from the content described above that when the automatic lens cleaning device in the disclosure is used, the cleaning assembly can be driven to move through the drive assembly since the automatic lens cleaning device is provided with the drive assembly and the cleaning assembly that are in driving connection. That is, the at least part of the cleaning assembly can move relative to the lens body under the action of the drive assembly in the disclosure. Thus, when the drive assembly drives the cleaning assembly to move relative to the lens body, the cleaning member of the cleaning assembly can clean the lens body, thus guaranteeing that the surface of the lens body is not covered with dirt. Thus, the automatic lens cleaning device in the disclosure effectively solves the problem that the self-propelled apparatus with the camera device cannot clean the camera device in the prior art.

### BRIEF DESCRIPTION OF DRAWINGS

In order to more clearly describe technical solutions in specific implementations of the disclosure or in the prior art, a brief introduction to accompanying drawings required for the description of the specific implementations or the prior art will be provided below. Apparently, the accompanying drawings in the following description show some implementations of the disclosure, and those of ordinary skill in the art can still derive other accompanying drawings from these accompanying drawings without creative efforts.

FIG. 1 is a schematic structural diagram of a lens cleaning device for a self-propelled apparatus according to Embodiment 1 of the disclosure.

FIG. 2 is a schematic diagram of a positional relationship between a mounting frame and a cleaning assembly of the lens cleaning device for a self-propelled apparatus according to Embodiment 1 of the disclosure.

FIG. 3 is a schematic structural diagram of a lens cleaning device for a self-propelled apparatus according to Embodiment 3 of the disclosure.

FIG. 4 is a schematic structural diagram of an automatic lens cleaning device according to Embodiment 1 of the disclosure.

FIG. 5 is a schematic diagram of a positional relationship between a lens body and a cleaning assembly of the automatic lens cleaning device according to Embodiment 1 of the disclosure.

FIG. 6 is a schematic structural diagram of a lawn mower provided by the present application.

FIG. 7 is a schematic structural diagram of a visual assembly, a cleaning assembly and a mounting seat in a lawn mower provided by the present application.

FIG. 8 is a schematic structural diagram of a lens body, a cleaning member and a mounting seat in a lawn mower provided by the present application.

FIG. 9 is a schematic structural diagram of a lens body and a cleaning member in another lawn mower provided by the present application.

FIG. 10 is a schematic flow diagram of a lens cleaning method for a lawn mower provided by the present application.

FIG. 11 is a schematic flow diagram of another lens cleaning method for a lawn mower provided by the present application.

FIG. 12 is a schematic structural diagram of a lens cleaning device for a lawn mower provided by the present application.

FIG. 13 is a schematic structural diagram of another lens cleaning device for a lawn mower provided by the present application.

FIG. 14 is a schematic structural diagram of an electronic apparatus provided by the present application.

Description of reference numerals:

110-mounting frame; 111-support section; 112-connection section; 120-cleaning assembly; 121-cleaning member; 122-connection portion; 1221-connection shaft; 1222-resetting member; 123-cleaning portion; 1231-first section; 1232-second section; 124-water storage tank; and 130-charging station body.

210-lens body; 211-convex edge; 220-cleaning assembly; 221-cleaning member; 222-base portion; and 230-mounting seat.

### DESCRIPTION OF EMBODIMENTS

The technical solutions of the disclosure will be described below clearly and comprehensively in conjunction with accompanying drawings. Apparently, embodiments described are merely some embodiments rather than all embodiments of the disclosure. The disclosure will be described in detail below with reference to the accompanying drawings and in conjunction with the embodiments. It should be noted that the embodiments in the disclosure and features in the embodiments can be combined mutually if there is no conflict.

It should be noted that the terms "first", "second", etc. in the description, the claims and the accompanying drawings of the disclosure are used to distinguish similar objects, but are not necessarily used to describe a specific sequence or a sequential order.

In the disclosure, the orientation words such as "up, down, top and bottom" usually indicate the directions shown in the accompanying drawings, or the vertical direction, the perpendicular direction or the gravity direction of the part itself unless otherwise stated. Similarly, for the convenience of understanding and description, "inside and outside" indicate the inside and the outside of the outline of each part itself, but the above orientation words are not used to limit the disclosure.

The disclosure solves the problem that a self-propelled apparatus with a camera device cannot clean the camera device in the prior art.

It should be noted that in the following embodiments of the disclosure, a self-propelled apparatus refers to a lawn mower, and a charging station for the self-propelled apparatus refers to a lawn mower charging station matching the lawn mower.

That is, in the following embodiments of the disclosure, a camera device on the lawn mower is cleaned when the lawn mower enters the lawn mower charging station.

It is clear that the self-propelled apparatus in the disclosure may alternatively be another self-propelled apparatus.

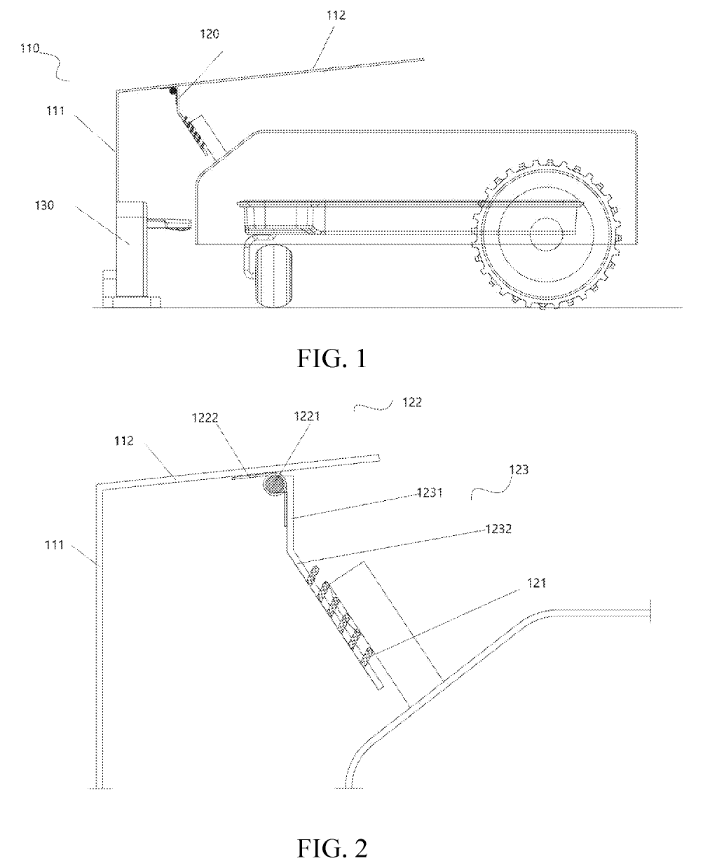

As shown in FIG. 1 and FIG. 2, a lens cleaning device for a self-propelled apparatus in this embodiment includes a mounting frame 110 and a cleaning assembly 120. The cleaning assembly 120 is movably connected to the mounting frame 110, an end, far away from the mounting frame 110, of the cleaning assembly 120 is provided with a cleaning member 121, and in a case that the cleaning member 121 is pressed by pressing external force, at least the cleaning member 121 moves relative to the mounting frame 110.

When the lens cleaning device for a self-propelled apparatus in the disclosure is used, in a case that the self-propelled apparatus is parked below the mounting frame 110, the self-propelled apparatus can press against the mounting frame 110 or a camera device of the self-propelled apparatus can come into contact with the cleaning member 121 during movement, such that the cleaning member 121 can clean the camera device of the self-propelled apparatus. Thus, the lens cleaning device for a self-propelled apparatus in the disclosure effectively solves the problem that the self-propelled apparatus with the camera device cannot clean the camera device in the prior art.

That is, when the self-propelled apparatus, that is, the lawn mower in this embodiment, needs to be charged or the camera device of the lawn mower needs to be cleaned since the camera device is covered with grass clippings or dirt, the lawn mower can be moved towards the mounting frame 110, and a lens of the camera device of the lawn mower can come into contact with the cleaning member 121 during the movement of the lawn mower. In addition, with continuous movement of the lawn mower, the lens can press against the cleaning member 121, such that the cleaning member 121 of the cleaning assembly 120 can move relative to the mounting frame 110, and part, abutting against the lens, of the cleaning member 121 can rub against the lens to remove the grass clippings or dirt covering a lens surface.

In addition, it should be pointed out that in the disclosure, a side, in contact with the lens, of the cleaning member 121 is provided with soft bristles.

In an embodiment, the cleaning assembly 120 in this embodiment includes a connection portion 122 and a cleaning portion 123. The connection portion 122 is connected to the mounting frame 110. One end of the cleaning portion 123 is connected to the connection portion 122, and the other end of cleaning portion 123 is provided with the cleaning member 121. In addition, the connection portion 122 includes a connection shaft 1221, the connection shaft 1221 is pivotally connected to the mounting frame 110, and the cleaning portion 123 is connected to the connection shaft 1221. With this arrangement, it can be guaranteed that the connection shaft 1221 of the connection portion 122 can rotate relative to the mounting frame 110 when the lens of the camera device abuts against the cleaning member 121 and presses against the cleaning member 121. Thus, the cleaning portion 123 can drive the cleaning member 121 to rotate along with the connection shaft 1221, and the bristles of the cleaning member 121 rubs against with a contact surface of the lens, to clean the lens.

In an embodiment, the connection portion 122 further includes a resetting member 1222, and the resetting member 1222 at least abuts between the cleaning portion 123 and the mounting frame 110, to provide resetting force for the cleaning portion 123.

In an embodiment, the resetting member 1222 is a torsion spring preferably. In this embodiment, the connection shaft 1221 passes through the torsion spring, and the torsion spring abuts against the mounting frame 110 and the cleaning portion 123. With this arrangement, the resetting force is provided for the connection shaft 1221 or the cleaning portion 123, and friction force between the bristles of the cleaning member 121 and the contact surface of the lens can be further increased by setting the torsion spring, thus improving a cleaning effect of the lens.

In an embodiment, the cleaning portion 123 includes a first section 1231 and a second section 1232 that are connected in sequence, an end, far away from the second section 1232, of the first section 1231 is connected to the connection shaft 1221, the second section 1232 is provided with the cleaning member 121, and the first section 1231 is arranged at an angle relative to the second section 1232. With this arrangement, the cleaning member 121 can better attach to the lens surface, and a better cleaning effect is achieved. Thus, in this embodiment, an included angle between the first section 1231 and the second section 1232 mainly matches a mounting angle of the lens on the lawn mower.

In an embodiment, the included angle between the first section 1231 and the second section 1232 is greater than 90 degrees.

In an embodiment, the second section 1232 is provided with the cleaning member 121 on a surface of an area where the first section 1231 and the second section 1232 form the included angle.

In an embodiment, an included angle between the second section 1232 and a vertical direction is greater than 0 degree and less than or equal to 45 degrees.

In an embodiment, the first section 1231 extends in the vertical direction.

In an embodiment, a length and a width of the cleaning member 121 are greater than a diameter of a lens. With such arrangement, it can be guaranteed that the cleaning member 121 can come into contact with the lens more comprehensively, thus obtaining the better cleaning effect. A plurality of cleaning members 121 may be provided certainly, different cleaning members 121 vary in length and width, and different cleaning members 121 may adapt to different lenses accordingly. Thus, in this embodiment, the case that the length and the width of the cleaning member 121 are greater than the diameter of the lens generally indicates that the length and the width of a selected cleaning member 121 need to be greater than the diameter of a lens to be cleaned.

In an embodiment, the mounting frame 110 includes a support section 111 and a connection section 112 that are connected in sequence. The connection section 112 is located above the support section 111, and the support section 111 extends in the vertical direction. An included angle is formed between the connection section 112 and a horizontal direction, and the cleaning assembly 120 is connected to the connection section 112 and is suspended below the connection section 112. That is, in this embodiment, a space for parking the lawn mower is provided below the connection section 112, such that it can be guaranteed that the lawn mower can move forward continuously after entering a position below the connection section 112, and the cleaning member 121 is caused to rub against the lens surface.

This embodiment is different from the embodiment described above in that in this embodiment, the cleaning assembly 120 further includes a drive portion and a detection portion. The drive portion is in driving connection to the cleaning member 121 and drives the cleaning member 121 to rotate. The detection portion is connected to the drive portion. With this arrangement, after the detection portion detects that the lens surface is in contact with the bristles of the cleaning member 121, a signal can be transmitted to the drive portion. Thus, the drive portion can drive the cleaning member 121 to rotate, to better clean the lens.

In an embodiment, the detection portion is a contact sensor or an infrared sensor.

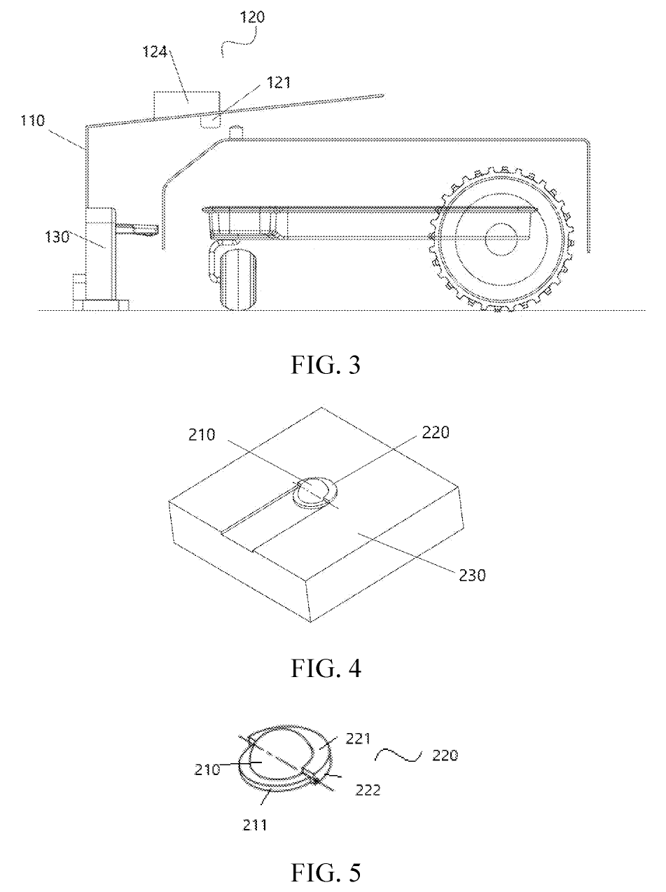

As shown in FIG. 3, this embodiment is different from the embodiment described above in that in this embodiment, the cleaning assembly 120 includes: a water storage tank 124, where the water storage tank 124 is arranged on the mounting frame 110. The cleaning member 121 is a cleaning cloth, and a cleaning liquid is contained in the water storage tank 124. One end of the cleaning cloth is arranged on the water storage tank 124 and soaked in the cleaning liquid, and the other end of the cleaning cloth is suspended below the water storage tank 124 under the action of gravity. That is, in this embodiment, the cleaning assembly 120 does not clean the lens of the camera device through a brush. Instead, when the lawn mower moves to a position below the mounting frame 110, the cleaning cloth comes into contact with the lens, and the lens can be wiped by the cleaning cloth along with the movement of the lawn mower. In addition, in this embodiment, the cleaning liquid may be water. The water in the water storage tank 124 can permeate the cleaning cloth, such that the cleaning cloth can be kept moist to guarantee the cleaning effect of the lens.

In this embodiment, a lower surface of the cleaning cloth is lower than a highest point of the lens with a drop not more than 5 mm. When the machine enters the charging station, the lens is in contact with the cleaning cloth. When the machine moves forward, the cleaning cloth completely wipes the lens surface and removes the grass clippings and the dirt on the lens.

As shown in FIG. 1 and FIG. 3, this embodiment provides a charging station for a self-propelled apparatus. The charging station includes a charging station body 130 and the lens cleaning device for a self-propelled apparatus of the embodiment described above. The charging station body 130 is arranged on a mounting frame 110 of the lens cleaning device for a self-propelled apparatus.

It can be seen from the description that the embodiment described above of the disclosure achieves the following technical effects:

1. The problem that the self-propelled apparatus with the camera device cannot clean the camera device in the prior art is effectively solved.

2. The performance is stable.

3. A structure is simple and disassembly is convenient.

Apparently, the embodiments described above are merely some embodiments rather than all embodiments of the disclosure. Based on the embodiments of the disclosure, other changes or modifications in different forms can be made by those of ordinary skill in the art without creative efforts and should fall within the protection scope of the disclosure.

It should be noted that in the following embodiment of the disclosure, a self-propelled apparatus refers to a lawn mower.

That is, in the following embodiment of the disclosure, an automatic lens cleaning device of the disclosure may be mounted on the lawn mower.

It is clear that the self-propelled apparatus in the disclosure may alternatively be another self-propelled apparatus.

As shown in FIG. 4 and FIG. 5, the automatic lens cleaning device in this embodiment includes a lens body 210, a drive assembly, and a cleaning assembly 220. At least part of the cleaning assembly 220 is arranged in a circumferential direction of the lens body 210, a side, facing the lens body 210, of the at least part of the cleaning assembly 220 is provided with a cleaning member 221, the drive assembly is in driving connection to the cleaning assembly 220 to cause at least the cleaning member 221 of the cleaning assembly 220 to move relative to the lens body 210, and the cleaning member 221 of the cleaning assembly 220 cleans a lens surface of the lens body 210.

It can be seen from the content described above that when the automatic lens cleaning device in the disclosure is used, the cleaning assembly 220 can be driven to move through the drive assembly since the automatic lens cleaning device is provided with the drive assembly and the cleaning assembly 220 that are in driving connection. That is, the at least part of the cleaning assembly 220 can move relative to the lens body 210 under the action of the drive assembly in the disclosure. Thus, when the drive assembly drives the cleaning assembly 220 to move relative to the lens body 210, the cleaning member 221 of the cleaning assembly 220 can clean the lens body 210, thus guaranteeing that the surface of the lens body 210 is not covered with dirt. Thus, the automatic lens cleaning device in the disclosure effectively solves the problem that the self-propelled apparatus with the camera device cannot clean the camera device in the prior art.

That is, when the camera device of the self-propelled apparatus, that is, the lawn mower in this embodiment is covered with the grass clippings or the dirt and needs to be cleaned, the drive assembly can be controlled to drive the cleaning assembly 220 to move, the cleaning member 221 can move relative to the surface of the lens body 210, and the cleaning member 221 can remove the grass clippings and the dirt on the surface of the lens body 210. Thus, an automatic navigation effect of the lawn mower is guaranteed.

It should be noted that in this embodiment, the drive assembly may include a drive motor arranged inside the lawn mower, and the cleaning member 221 of the cleaning assembly 220 is driven by the driving motor to move relative to the lens body 210.

In an embodiment, the automatic lens cleaning device further includes a mounting seat 230. The lens body 210 and the cleaning assembly 220 are arranged on the mounting seat 230. Since the automatic lens cleaning device is arranged on the lawn mower in this embodiment, stability between the lens body 210 and the cleaning assembly 220 can be effectively ensured by arranging the mounting seat 230. In an embodiment, it can be guaranteed that the cleaning assembly 220 can clean the lens body 210 in a preset direction, and can be prevented from inclining during the movement of the cleaning assembly 220 relative to the lens body 210. In addition, by arranging the mounting seat 230, a mounting position can be further provided for the automatic lens cleaning device when mounted on the lawn mower.

In an embodiment, the cleaning assembly 220 is movably arranged on the mounting seat 230, the drive assembly drives the cleaning assembly 220 to move along a preset path, and in a case that the cleaning assembly 220 moves along the preset path, at least part of the cleaning assembly 220 comes into contact with different positions of the lens body 210. With this arrangement, it can be guaranteed that the cleaning assembly 220 can clean an exposed portion of the lens body 210 in all directions, to better clean the surface of the lens body 210, and the cleaning effect of the automatic lens cleaning device is further guaranteed.

In this embodiment, two ends of the cleaning assembly 220 are connected to the mounting seat 230, and the drive assembly drives the cleaning assembly 220 to rotate relative to the mounting seat 230. In addition, in this embodiment, the exposed portion of the lens body 210 is hemispherical, and the cleaning assembly 220 cleans the exposed hemispherical portion of the lens body 210. That is, in this embodiment, when the drive assembly drives the cleaning assembly 220 to move relative to the lens body 210, the cleaning member 221 of the cleaning assembly 220 can clean the exposed surface of the lens body 210, and the movement path of the cleaning member 221 corresponds to the hemispherical surface of the lens body 210. In other words, in this embodiment, when the drive assembly drives the cleaning assembly 220 to rotate relative to the mounting seat 230, the cleaning assembly 220 rotates along an outer surface of the exposed hemispherical surface of the lens body 210, thus forming the movement path of the hemispherical surface.

In an embodiment, the cleaning assembly 220 further includes a base portion 222, two ends of the base portion 222 are rotatably connected to the mounting seat 230, and the cleaning member 221 is arranged at a side, facing the lens body 210, of the base portion 222 and extends towards the lens body 210. That is, in this embodiment, the drive assembly is in driving connection to the base portion 222 and can drive the base portion 222 to rotate relative to the lens body 210, such that the base portion 222 can drive the cleaning member 221 to move relative to the lens body 210, and then the cleaning member 221 can clean the exposed surface of the lens body 210 during movement.

In this embodiment, the cleaning member 221 may be soft bristles arranged on the base portion 222.

In an embodiment, a surface of the side, on which the cleaning member 221 is mounted, of the base portion 222 is a camber, and a diameter of the camber is greater than a diameter of the lens body 210. With this arrangement, a better attaching effect can be guaranteed between the cleaning member 221 and the lens body 210, such that the exposed surface of the lens body 210 can be cleaned more effectively.

In this embodiment, the periphery, close to the two ends of the base portion 222, of the lens body 210 is provided with convex edges 211, and the base portion 222 is arranged around the convex edge 211 when the base portion 222 is not moving. A height of the base portion 222 is higher than a height of the convex edge 211, thus guaranteeing that the cleaning member 221 is located above the convex edge 211 and the cleaning member 221 can clean the surface of the lens body 210 during movement of the base portion 222.

In an embodiment, a distance between an end, close to the lens body 210, of the cleaning member 221 and the lens body 210 is less than or equal to 5 mm. In this embodiment, the self-propelled apparatus is the lawn mower, and the lens surface of the lawn mower is generally covered with the grass clippings or the dirt, the cleaning member 221 can clean the grass clippings and the dirt off the surface of the lens body 210 even if there is a gap between the cleaning member 221 and the outer surface of the lens body 210. In addition, this arrangement can effectively prevent the cleaning member 221 from causing wear on the surface of the lens body 210.

In an embodiment, a rotation angle of the cleaning assembly 220 is greater than or equal to 120 degrees. In this embodiment, the rotation angle of the cleaning assembly 220 mainly depends on a photographing angle of the lens body 210. Thus, the rotation angle of the cleaning assembly 220 can be changed according to an actual photographing angle of the lens body 210, thus guaranteeing that the lens body 210 is not covered by the grass clippings and the dirt during photographing.

In an embodiment, a connection line of the two ends, connected to the mounting seat 230, of the cleaning assembly 220 passes through a circle center of the lens body 210. With this arrangement, it can be effectively guaranteed that the cleaning assembly 220 does not collide with the lens body 210 except cleaning during movement of the cleaning assembly 220 relative to the lens body 210, such that stable operation of the cleaning assembly 220 is guaranteed.

It should be noted that the movement of the cleaning assembly relative to the lens body adopts a movement form that the lens remains stationary, while the cleaning assembly rotates relative to the lens body. Thus, the lens body is cleaned by the cleaning assembly.

In this embodiment, when the drive assembly drives the cleaning assembly to move relative to the lens body, the cleaning assembly further moves linearly on the mounting seat at the same time. In addition, during the movement of the cleaning assembly, the cleaning member of the cleaning assembly passes through different portions of the exposed surface of the lens body in turn, and cleans the lens body accordingly. Thus, in this embodiment, the two ends of the cleaning assembly are slidably connected to the mounting seat, to cause the drive assembly to drive the cleaning assembly to slide relative to the mounting seat.

In an embodiment, in this embodiment, the drive assembly may include a drive motor and a stretchable rod in driving connection to the drive motor. The drive motor drives the stretchable rod to stretch and retract, to cause the stretchable rod to drive the cleaning assembly to slide on the mounting seat.

It is clear that in this embodiment, in addition to the drive method by which the cleaning assembly is driven to slide relative to the mounting seat by the stretchable rod, another drive connection structure may alternatively be used by the drive assembly, as long as the cleaning assembly can slide relative to the mounting seat.

In the embodiment described above, timing for the drive assembly to drive the cleaning assembly to move may be determined as follows: an operator controls the drive assembly to drive the cleaning assembly to move according to observation of the lens body.

In this embodiment, the automatic lens cleaning device can implement determination according to an image shot by the lens body, and the drive assembly can control the cleaning assembly to clean the lens body according to a determination result. Thus, in this embodiment, the automatic lens cleaning device further includes a control assembly. The control assembly is in signal connection to the lens body and the drive assembly. In addition, the control assembly is configured to receive an image signal from the lens body, and the control assembly may determine whether to control the drive assembly to drive the cleaning assembly to move according to the image signal.

It should be noted that in the embodiment of the disclosure, when the drive assembly drives the cleaning assembly to move, a movement form of the cleaning assembly is reciprocating. In addition, a number of reciprocating movements of the cleaning assembly may be adjusted according to the actual use. Alternatively, the number of reciprocating movements of the cleaning assembly may be changed according to cleanliness of the lens body.

It can be seen from the description that the embodiment described above of the disclosure achieves the following technical effects:

1. The problem that the self-propelled apparatus with the camera device cannot clean the camera device in the prior art is effectively solved.

2. The performance is stable.

3. A structure is simple and disassembly is convenient.

Apparently, the embodiments described above are merely some embodiments rather than all embodiments of the disclosure. Based on the embodiments of the disclosure, other changes or modifications in different forms can be made by those of ordinary skill in the art without creative efforts and should fall within the protection scope of the disclosure.

Reference will now be made in detail to exemplary embodiments, examples of which are illustrated in the accompanying drawings. When the following description refers to the drawings, the same numerals in different drawings represent the same or similar elements unless otherwise indicated. The implementations described in the following exemplary embodiments do not represent all implementations consistent with the present application. Rather, they are merely examples of apparatus and methods consistent with some aspects of the present application as recited in the appended claims.

Generally, lawn mowers equipped with visual recognition functions available on the market can collect images or videos of the surrounding environment through a lens body, so as to provide visual data support for intelligent operations such as obstacle avoidance and path planning of the lawn mowers. However, for such intelligent lawn mowers equipped with the lens body on the body, the lens of the lens body is easily adhered with debris such as grass clippings, dust and dirt generated during operation, resulting in blurred imaging or even failure of the lens. This directly affects the environmental perception capability of the lens body, thereby leading to a significant decrease in the operational stability of functions such as obstacle avoidance and path planning. Under normal circumstances, such lawn mowers require users to wipe the lens frequently, which reduces the intelligent level of the lawn mowers and affects the user experience.

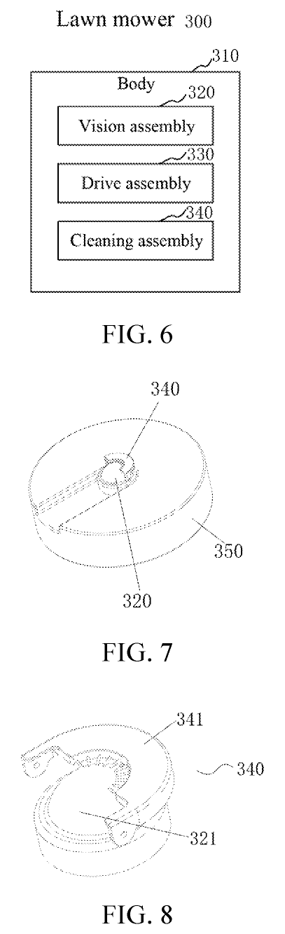

As shown in FIG. 6, the present application provides a lawn mower 300. The lawn mower 300 includes a body 310, and a vision assembly 320, a drive assembly 330, and a cleaning assembly 340 provided on the body 310.

Exemplarily, the body may be circular, square, or other shapes, such as a special shape formed by combining a part of the circular and a part of the square. The body may rotate during moving, and the center point about which the rotation is performed may be a center point selected from the body. For example, when the body is circular, the center point may include the center of the circular; for another example, when the body is square, the center point may include the center point of the square; for still another example, when the body is provided with two drive wheels, the center point may include the center point of a connecting line of the two drive wheels or the center point of a connecting line of rotation centers of the two drive wheels.

As shown in FIG. 7 and FIG. 8, the vision assembly 320 includes, for example, a lens body 321; a cleaning member 341 is provided on a side of the cleaning assembly 340 facing the lens body 321; and the drive assembly 330 is connected to the cleaning member 341 for driving the cleaning member 341 to move relative to the lens body 321 so as to clean the lens body 321.

For example, the drive assembly may be a structure that provides power for the cleaning member 341, and may generally include a motor, gears, a transmission mechanism, etc. The drive assembly is configured to drive the cleaning member 341 to move, so as to clean the lens body 321. The cleaning member 341 refers to a component that is in direct contact with an exposed surface of the lens body 321 and can perform a wiping and cleaning action. Specifically, the cleaning member 341 may be a brush, a scraper, a cleaning cotton pad, a rubber wiper strip, or the like.

For example, at least a part of the cleaning assembly 340 may be arranged circumferentially around the lens body 321. A side, facing the lens body, of at least a part of the cleaning assembly 340 is provided with the aforementioned cleaning member 341. The drive assembly 330 is drivingly connected to the cleaning assembly 340, so that at least the cleaning member 341 of the cleaning assembly 340 moves relative to the lens body 321. When the drive assembly 330 drives the cleaning member 341 of the cleaning assembly 340 to move relative to the lens body, the cleaning member 341 of the cleaning assembly 340 can sweep the lens body 321, thereby ensuring that the surface of the lens body 321 is not covered by debris.

Alternatively, one end of the cleaning assembly 340 may be detachably provided on the body 310. Under the action of the drive assembly 330, the cleaning assembly 340 performs a rotating movement on a specific plane about an axis that is an end of the cleaning assembly 340 connected to the body 310, so that at least the cleaning member 341 of the cleaning assembly 340 moves relative to the lens body 321, enabling the cleaning member 341 of the cleaning assembly 340 to sweep the lens surface of the lens body 321.

It should be noted that the present application imposes no restrictions on the specific integration manner of the cleaning assembly 340 on the body 310, as long as the cleaning member 341 of the cleaning assembly 340 can move relative to the lens body 321 under the action of the drive assembly 330, and the cleaning member 341 can clean the lens surface of the lens body 321 during the relative movement of the cleaning member 341.

In the present embodiment, the drive assembly may include a drive motor provided inside the lawn mower, and drives, by the drive motor, the cleaning member 341 of the cleaning assembly 340 to move relative to the lens body 321.

As shown in FIG. 7, for example, the lawn mower further includes a mounting seat 350, and the lens body 321 and the cleaning assembly 340 are respectively provided on the mounting seat 350. By providing the mounting seat 350, the lawn mower can effectively ensure the stability between the lens body 321 and the cleaning assembly 340, thereby ensuring that the cleaning member 341 can clean the lens body 321 in a preset direction on a specific plane without deviation during the moving of the cleaning member 341 relative to the lens body 321.

In one embodiment, the cleaning assembly 340 may be movably provided on the mounting seat 350, and the drive assembly 330 drives the cleaning assembly 340 to move along a preset path. When the cleaning assembly 340 moves along the preset path, at least a part of the cleaning assembly 340 comes into contact with different positions of the lens body 321 respectively. By this arrangement, it can ensure that the cleaning assembly 340 can perform omnidirectional cleaning on an exposed portion of the lens body 321, thereby better cleaning the surface of the lens body 321 and further guaranteeing the cleaning effect of the lawn mower.

For example, both ends of the cleaning assembly 340 are connected to the mounting seat 350 respectively, and the drive assembly 330 drives the cleaning assembly 340 to rotate relative to the mounting seat 350. Moreover, in the present embodiment, the exposed portion of the lens body 321 is hemispherical, and the cleaning assembly 340 sweeps the exposed hemispherical portion of the lens body 321. That is to say, in the present embodiment, when the drive assembly 330 drives the cleaning assembly 340 to move relative to the lens body, the cleaning member 341 of the cleaning assembly 340 can sweep the exposed surface of the lens body 321, and a moving path of the cleaning member 341 corresponds to the hemispherical surface of the lens body 321. Alternatively, in the present embodiment, when the drive assembly 330 drives the cleaning assembly 340 to rotate relative to the mounting seat 350, the cleaning assembly 340 rotates along an outer surface of the exposed hemispherical surface of the lens body 321, thereby forming a hemispherical moving path.

As shown in FIG. 8, in another embodiment, one end of the cleaning assembly 340 may be movably provided on the mounting seat 350, and the drive assembly 330 drives entire cleaning assembly 340 to swing, such that the cleaning assembly 340 rotates within a specific plane about an axis that is an end of the cleaning assembly 340 movably connected to the mounting seat 350, thereby enabling at least a part of the cleaning member 341 to come into contact with different positions of the lens body 321. By this arrangement, it can ensure that the cleaning assembly 340 can perform omnidirectional cleaning on the exposed portion of the lens body 321, thereby better cleaning the surface of the lens body 321 and further guaranteeing the cleaning effect of the lawn mower.

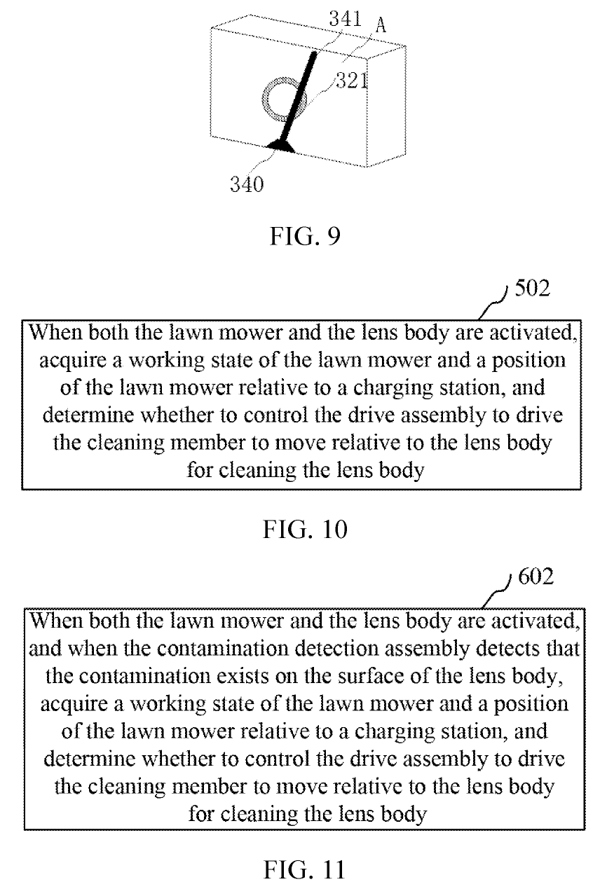

As shown in FIG. 9, for example, in the present embodiment, the exposed portion of the lens body 321 may be integrated on a display surface A, which includes a planar portion other than the lens body and a hemispherical portion corresponding to the lens body 321. The cleaning area corresponding to the cleaning assembly 340 may, for example, be regarded as a rectangular plane and the cleaning assembly 340 sweeps the rectangular planar portion. That is to say, in the present embodiment, when the drive assembly 330 drives the cleaning assembly 340 to move relative to the lens body, the cleaning member 341 of the cleaning assembly 340 can sweep the surface of the rectangular plane. It should be noted that the outer surface of the exposed hemisphere of the lens body 321 may protrude from the rectangular plane. That is to say, in the present embodiment, when the drive assembly 330 drives the cleaning assembly 340 to rotate relative to the mounting seat 350, the cleaning assembly 340 rotates along the rectangular plane, thereby forming a fan-shaped moving path. The cleaning member 341 may, for example, come into contact with the outer surface of the exposed hemispherical surface of the lens body 321, so as to clean the outer surface of the lens body 321.

It should be noted that the integrated form and structural style of the cleaning assembly 340, cleaning member 341, lens body 321 and display surface A shown in FIG. 9 are for reference only, and other cleaning assemblies 340, cleaning members 341, lens bodies 321 and display surfaces A with different structures shall fall within the protection scope of the present application.

In another embodiment, one end of the cleaning assembly 340 may be slidably provided in a slide rail on the mounting seat 350, and the drive assembly 330 drives the cleaning assembly 340 to slide, so that the cleaning assembly 340 can perform reciprocating movement in the slide rail, thereby enabling at least a part of the cleaning member 341 to come into contact with different positions of the lens body 321. By this arrangement, it can ensure that the cleaning assembly 340 can perform omnidirectional cleaning on the exposed portion of the lens body 321, thereby better cleaning the surface of the lens body 321 and further guaranteeing the cleaning effect of the lawn mower.

It should be noted that, in the embodiment of the present application, when the drive assembly drives the cleaning assembly to move, a moving form of the cleaning assembly is reciprocating movement. In addition, the number of reciprocating movements of the cleaning assembly can be adjusted according to actual usage conditions. Alternatively, the number of reciprocating movements of the cleaning assembly can be changed according to the cleanliness of the lens body.

In an embodiment, the lawn mower is further provided with a storage assembly, and a control assembly and the storage assembly may be provided inside the lawn mower. In an embodiment, the storage assembly may be integrated with the control assembly, or may also be two separate components.

The storage assembly is configured to store data; for example, various software control programs, certain modes and/or parameters of the lawn mower, and the like. Specifically, the programs may include program codes, and the program codes include computer operation instructions.

The control assembly may include, for example, one or more circuits or chips with control functions.

The control assembly is configured to control the operation of the lawn mower and respond to user operations through various software control programs stored in the storage assembly.

In one embodiment, the lawn mower is further provided with a contamination detection assembly, which is communicatively connected to the lens body, and the contamination detection assembly is configured to detect contamination on the surface of the lens body when the lens body is activated.

For example, the contamination detection assembly may be independent equipment, including an image acquisition device, a memory, a processor, and a computer program stored in the memory and executable on the processor. In this embodiment, the image acquisition device in the contamination detection assembly is provided facing the lens body, and is configured to collect an actual image corresponding to the surface of the lens body.

The processor may obtain the image collected by the image acquisition device and input the image into an image anomaly detection model, so as to identify whether there is an abnormal area in the image that affects image quality and obtain a contamination category of the abnormal area. Then, the processor acquires depth information of the abnormal area and determines whether actual contamination corresponding to the contamination category exists in the abnormal area according to the depth information, so as to finally obtain a contamination verification result.

In this embodiment, the processor of the contamination detection assembly is communicatively connected to the lens body and the control assembly respectively. When the lens body is activated, the processor may control the image acquisition device to collect an image corresponding to the surface of the lens body and perform contamination detection. When a contamination verification result is obtained, the processor sends the contamination verification result to the control assembly. When the contamination verification result indicates that contamination exists on the surface of the lens body, the control assembly controls the drive assembly to drive the cleaning member to move relative to the lens body so as to clean the lens body.

Alternatively, the contamination detection assembly may be a sensor. In this embodiment, the sensor is provided facing the lens body and configured to collect an actual image corresponding to the surface of the lens body.

The contamination detection assembly is, for example, an infrared sensor. Infrared light emitted by the infrared sensor may vertically irradiate the lens surface, and the infrared sensor further receives reflected light. The control assembly determines whether contamination exists on the surface of the lens body based on parameters of the reflected light. If the surface of the lens body is clean, the intensity and angle of the reflected light are consistent with preset light parameters. If the contamination exists on the surface of the lens body, the reflected light will be scattered or absorbed by the contamination, and the signal of the reflected light will be attenuated or deviated, so that the control assembly can quickly confirm that contamination exists on the surface of the lens body.

Alternatively, the contamination detection assembly is an image acquisition device. When the lens body is activated, the contamination detection assembly collects an image corresponding to the surface of the lens body and sends the image to the control assembly. The control assembly performs contamination detection based on the image. When the contamination verification result indicates that the contamination exists on the surface of the lens body, the control assembly controls the drive assembly to drive the cleaning member to move relative to the lens body so as to clean the lens body.

It should be noted that the present application imposes no restrictions on the specific device of the contamination detection assembly or the form of information interaction between the contamination detection assembly and the control assembly to determine whether the contamination exists on the lens body, as long as detection of whether contamination exists on the surface of the lens body can be realized.

In the above embodiments, the timing for the drive assembly to drive the cleaning assembly to move may be automatically set by the control assembly mounted on the lawn mower. The lawn mower can make a judgment according to images or videos collected by the lens body, so that the drive assembly can control the cleaning assembly to clean the lens body according to the judgment result. The control assembly is in signal connection with the lens body and the drive assembly respectively. The control assembly is configured to receive image signals or video signals from the lens body, and can make a judgment according to the image signals or video signals so as to control whether the drive assembly drives the cleaning assembly to move.

In an embodiment, a lens cleaning method for a lawn mower is provided. The execution subject of the lens cleaning method may be a control assembly in the lawn mower, or a server corresponding to the lawn mower. The server is located in the cloud, is connected to the control assembly of the lawn mower via a network, and issues trigger instructions to the lawn mower, or forwards trigger instructions, which are sent by a user through a terminal communicatively connected to the lawn mower, to the lawn mower, and so on.

In the present embodiment, the lens cleaning method being applied to the control assembly is taken as an example for illustration. As shown in FIG. 10, the lens cleaning method includes: step 502, when both the lawn mower and the lens body are activated, acquiring a working state of the lawn mower and a position of the lawn mower relative to a charging station, and determining whether to control the drive assembly to drive the cleaning member to move relative to the lens body for cleaning the lens body; the working state includes a trigger instruction receiving state, a triggered state and a standby state; the trigger instruction receiving state refers to a state of the lawn mower from receiving a trigger instruction to prior to performing a work task corresponding to the trigger instruction; the triggered state is a state of performing the work task corresponding to the trigger instruction; the standby state is a state in which the lawn mower is activated and does not receive the trigger instruction, or in which the lawn mower has completed a previous work task and does not receive a new trigger instruction; the position of the lawn mower relative to the charging station includes that the lawn mower is located inside the charging station or outside the charging station.

The lawn mower is activated, which means that the lawn mower is powered on and the control program of the control assembly starts running. The lens body is activated, which means that the vision assembly on the lawn mower is powered on and starts operating. For example, the lens body is activated when the lawn mower enters a vision obstacle avoidance mode; alternatively, the lens body can also be activated when a user uses a terminal communicatively connected to the lawn mower to view, by retrieving images or videos acquired in real time by the lens body, the current position of the lawn mower.

Before activating the lens body, the control assembly may further determine whether to activate the lens body based on information such as the position of the lawn mower relative to the charging station, time, and the like. For example, when a user controls, by using a terminal communicatively connected to the lawn mower, the lawn mower to enter the vision obstacle avoidance mode, the control assembly may first determine whether the lawn mower is being charged. If yes, the control assembly does not activate the lens body; if no, the control assembly activates the lens body. Alternatively, the control assembly may further determine whether the current time falls within a preset time period. If yes, the control assembly activates the lens body; otherwise, it does not activate the lens body. The preset time period may correspond to daytime, for example.

In the present embodiment, the control assembly performs automatic lens cleaning only when the vision assembly is activated and in use, and does not trigger automatic lens cleaning when the lens body is not in use.

The trigger instruction refers to a signal for controlling the lawn mower to perform a specific work task. For example, the trigger instruction may be issued by a user via a terminal communicatively connected to the lawn mower body, or by directly pressing a button on the lawn mower. The trigger instruction may also be generated automatically at a user‑preset operation time, or generated automatically based on an actual state of the lawn mower. For example, a return-to-charge instruction may be generated automatically when the battery level of the lawn mower is low, so that the lawn mower is controlled to perform a return-to-charge task.

The work task includes at least a mowing task, a map construction task, and a return-to-charge task.

The trigger instruction receiving state refers to a state of the lawn mower in a time period from receiving the trigger instruction to prior to actually performing the work task corresponding to the trigger instruction.

In the trigger instruction receiving state, the lawn mower may perform posture adjustment. For example, when the lawn mower is located in the charging station, it may perform an outgoing action; when the lawn mower is in a non-stationary posture, it may perform the posture adjustment action to restore the body of the lawn mower to a normal working posture. The non-stationary posture means that the lawn mower is in an unstable posture, for example, the body of the lawn mower has an excessive inclination angle, drive wheels are suspended or off the ground, which may cause the lawn mower to roll over or tip over, cause the lawn mower to be lifted up, or cause the lawn mower to be stuck on steps. The normal working posture means, for example, that the body of the lawn mower returns to be straightened, all drive wheels are on the ground, and the inclination angle of the body is within a safe range.

The triggered state means that the lawn mower has received the trigger instruction and is performing the actual work task corresponding to the instruction, such as the mowing task, the return-to-charge task, the map construction task, and the like.

The standby state means that the lawn mower has been activated and is operating normally, but currently has no work tasks to perform, and is in an idle waiting state.

Specifically, if the user controls the lawn mower to power on and activate via the terminal communicatively connected to the lawn mower, the lawn mower enters the standby state until it receives a trigger instruction sent by the user via the terminal, and then further enters the trigger instruction receiving state. Alternatively, the lawn mower receives a trigger instruction, enters the triggered state and performs the corresponding work task; and the lawn mower enters the standby state upon completing the work task and not receiving a new trigger instruction. Alternatively, during the process where the lawn mower receives the trigger instruction, enters the triggered state, and perform the corresponding work task, if a fault is detected that prevents the lawn mower from continuing the work task, the lawn mower waits for a preset duration; if the fault is not cleared, the lawn mower terminates the work task and enters the standby state. It should be noted that in this case, the lawn mower may also send prompt information to notify the user of the fault. The prompt information may be displayed in the form of body vibration, light emission, or prompt tones of the lawn mower, or in the form of text prompts via the user’s corresponding terminal.

Being located inside the charging station means that the body of the lawn mower has completely entered a physical area of the charging station and is parked at a charging interface or a designated parking position.

Being located outside the charging station means that the lawn mower is not within the physical area of the charging station. In this time, the lawn mower may be performing a specific work task outdoors, or may stay at a certain position in the standby state.

For example, the control assembly may determine whether the lawn mower is inside the charging station via a sensing assembly built into the charging station. When the lawn mower enters the charging station and the sensing assembly detects a signal, it may be determined that the lawn mower is inside the charging station; if no signal is detected, it may be determined that the lawn mower is outside the charging station. The sensing assembly may be, for example, an infrared sensor, an ultrasonic sensor, a card reader, or the like.

Alternatively, the control assembly may determine whether the lawn mower is inside the charging station via positioning modules built in the charging station and the lawn mower. The control assembly may acquire the position uploaded by the charging station and the real-time position uploaded by the lawn mower, and judge whether the position corresponding to the lawn mower falls within a preset range of the position corresponding to the charging station. If yes, it may be determined that the lawn mower is inside the charging station; otherwise, it is determined that the lawn mower is outside the charging station.

Generally, in conventional lens cleaning methods for lawn mowers, the lens body is cleaned at a fixed frequency, cleaning action is performed mechanically regardless of whether the lens body is contamination or in use. This not only causes excessive wear of the cleaning member and energy waste of the drive assembly, but may also block the lens body at critical moments when the lawn mower performs obstacle surmounting or obstacle avoidance task, thereby impairing the vision function of the lawn mower.

The above lens cleaning method for a lawn mower realizes automatic cleaning of the lawn mower lens through an intelligent control logic. When the lawn mower is powered on and the lens body is activated, i.e., when the lens body is actually required for use, a dual judgment is further made on the working state of the lawn mower and its relative position to the charging station to determine whether to trigger a corresponding cleaning operation, thereby realizing intelligent cleaning of the lens body.

This mechanism not only avoids loss caused by unnecessary cleaning, but also ensures that the lens body of the lawn mower remains clean during use to collect clear images or videos. This effectively improves the visual navigation accuracy, obstacle avoidance performance and operation integrity of the lawn mower, and reduces problems such as missed mowing, repeated mowing and collisions. At the same time, the fully automatic intelligent cleaning logic completely eliminates the user's operational burden of manual wiping, without requiring the user to judge the cleaning timing or frequently replace the cleaning member, which significantly reduces the use cost of the lawn mower and enhances the user experience.

In some embodiments, the lens cleaning method for the lawn mower further includes: when the lawn mower is in the trigger instruction receiving state and is located outside the charging station, controlling the drive assembly to drive the cleaning member to move relative to the lens body for cleaning the lens body; after surface cleaning of the lens body is completed, controlling the lawn mower to perform the work task; when the lawn mower is in the trigger instruction receiving state and is located inside the charging station, controlling the lawn mower to move away from the charging station for outgoing until the lawn mower is located outside the charging station, controlling the lawn mower to stop moving, and controlling the drive assembly to drive the cleaning member to move relative to the lens body for cleaning the lens body; after the surface cleaning of the lens body is completed, controlling the lawn mower to perform the work task; when the lawn mower is in the standby state and is located outside the charging station, controlling the drive assembly to drive the cleaning member to move relative to the lens body for cleaning the lens body; when the lawn mower is in the standby state and is located inside the charging station, controlling the cleaning assembly not to perform cleaning.

After the lawn mower is powered on and activated, there are three working states: the trigger instruction receiving state, the triggered state and the standby state.

In the present embodiment, if the lawn mower is in the trigger instruction receiving state, it may be considered that the lawn mower has received a trigger instruction and is in the stage of instruction parsing or waiting for execution. At this time, the control assembly further determines the specific position of the lawn mower. If the lawn mower is inside the charging station, the control assembly may control the lawn mower to perform an outgoing action until the lawn mower moves outside the charging station and stops moving, and then control the drive assembly to drive the cleaning member to move relative to the lens body. If the lawn mower is outside the charging station, the control assembly may directly control the drive assembly to drive the cleaning member to move relative to the lens body, so as to complete automatic cleaning of the lens body.

The outgoing action means that the lawn mower moves in a direction away from the charging station along a preset outgoing path. The outgoing path may be, for example, a straight path toward the exit of the charging station.

During the process that the lawn mower performs the outgoing action, the control assembly may monitor the position of the lawn mower in real time to ensure that the lawn mower travels along the outgoing path and avoid collision with the charging station or surrounding obstacles. For example, the control assembly may further preset an outgoing distance threshold. When the lawn mower is controlled to perform the outgoing action and the moving distance reaches the outgoing distance threshold, it is determined that the lawn mower is outside the charging station. At this time, the control assembly controls the lawn mower to stop moving and perform the subsequent automatic cleaning. Alternatively, when the current position of the lawn mower is not within the preset range corresponding to the position of the charging station, the control assembly determines that the lawn mower is outside the charging station, and then controls the lawn mower to stop moving and perform the subsequent automatic cleaning.

If the lawn mower is in the standby state, the control assembly further determines the specific position of the lawn mower. When the lawn mower is inside the charging station, the control assembly is controlled to drive the cleaning member to move relative to the lens body, a collision between the cleaning member and the charging station may occur. Moreover, since the lawn mower is not performing any specific work task at this time, there is no need to ensure the visual navigation accuracy, obstacle avoidance effect and operation integrity of the lawn mower. Even if the contamination adheres to the surface of the lens body, it will not affect the operation of the lawn mower. Furthermore, if the lawn mower needs to perform a specific work task later, the cleaned lens body may be re‑contaminated during performing the outgoing action, making it difficult to maintain the effect of automatic cleaning inside the charging station. In addition, automatic cleaning motion will be performed after the lawn mower completes the outgoing task, the drive assembly is controlled to drive the cleaning member to move relative to the lens body. Therefore, automatic cleaning of the lens body inside the charging station is unnecessary, and the control assembly directly controls the drive assembly not to drive the cleaning assembly, i.e., no cleaning is performed on the lens body.

It should be noted that if the lawn mower is in the standby state and outside the charging station, after the control assembly controls the drive assembly to drive the cleaning member to complete one automatic cleaning of the lens body, it may continue to control the drive assembly to drive the cleaning member to move relative to the lens body at a preset frequency, so as to realize multiple subsequent automatic cleanings of the lens body. In this scenario, the lawn mower is located outside the charging station and is highly likely to be adhered with debris such as grass clippings, dust and dirt, resulting in a high possibility that the lens imaging is blurred or even invalid. It can keep the surface of the lens body clean by periodic automatic cleaning, so as to prevent excessive stains from adhering to the surface of the lens body when the lawn mower waits outside the charging station for a long time, which would otherwise affect the clarity of collected images or videos.

In an embodiment, during the process that the control assembly controls the drive assembly to drive the cleaning member to move relative to the lens body, the control assembly controls the drive assembly to drive the cleaning member to perform reciprocating movement relative to the lens body, so as to wipe and clean the surface of the lens body back and forth.

Alternatively, the control assembly performs differentiated control over the drive assembly based on the working state of the lawn mower. For example: when the lawn mower is in the trigger instruction receiving state, it is about to perform a work task, and a relatively high level of cleanliness is required for the surface of the lens body at this time, and thus the control assembly may control the drive assembly to drive the cleaning member to perform reciprocating movement relative to the lens body for a greater number of times, so as to perform high-intensity cleaning on the surface of the lens body. When the lawn mower is in the standby state, it has no need to perform a work task and the current cleaning is routine, the control assembly may control the drive assembly to drive the cleaning member to perform reciprocating movement relative to the lens body for a fewer number of times, so as to perform low-intensity cleaning on the surface of the lens body.

Through differentiated control of the drive assembly, the control assembly can control the drive assembly to drive the cleaning member to perform reciprocating movement relative to the lens body for different numbers of times, thereby achieving different degrees of lens cleaning. When the lawn mower has no need to perform a work task, excessive cleaning actions are avoided, which would otherwise cause loss of the cleaning member and power consumption of the lawn mower.

Furthermore, after the control assembly controls the drive assembly to drive the cleaning member to move relative to the lens body and clean the surface of the lens body, it may also control the drive assembly to drive the cleaning member to return to its original position.

The above lens cleaning method for the lawn mower can directly perform automatic cleaning when the lawn mower is in the trigger instruction receiving state and outside the charging station, so as to quickly remove stains such as grass clippings and floating dust on the lens surface in an outdoor environment, ensuring that the lawn mower can collect clear images or videos when performing work tasks. If the lawn mower is in the trigger instruction receiving state and inside the charging station, the lawn mower is controlled to automatically move out of the charging station and then performs cleaning, which ingeniously avoids the problem of secondary contamination caused by cleaning inside the charging station before moving out, making the cleaning effect more durable. When the lawn mower is in the standby state and outside the charging station, automatic cleaning is directly performed to avoid the risk of contamination from the complex outdoor environment. When the lawn mower is in the standby state and inside the charging station, if the drive assembly is controlled to drive the cleaning member to move relative to the lens body, a collision between the cleaning member and the charging station may occur. Moreover, since the lawn mower is not performing any specific work task at this time, there is no need to ensure the visual navigation accuracy, obstacle avoidance effect and operation integrity of the lawn mower. Even if the contamination adheres to the surface of the lens body, the operation of the lawn mower will not be affected. Furthermore, if the lawn mower needs to perform a specific work task later, the cleaned lens body may be re-contaminated during performing the outgoing action, making it difficult to maintain the effect of automatic cleaning inside the charging station. In addition, automatic cleaning will be performed after the lawn mower completes the outgoing task, the drive assembly is controlled to drive the cleaning member to move relative to the lens body. Therefore, automatic cleaning of the lens body inside the charging station is unnecessary, so the cleaning action is not initiated, avoiding invalid consumption and saving energy.

In some embodiments, the lens cleaning method for the lawn mower further includes: when the lawn mower is in the triggered state, controlling the drive assembly to drive the cleaning member to move relative to the lens body for cleaning the lens body at a preset frequency.

In an embodiment, the control assembly may also differentially adjust the preset frequency according to different work tasks, for example.

For example, the work tasks include a mowing task, a map construction task and a return-to-charge task. When the lawn mower is in the triggered state and performing the mowing task, it may be located in an area with dense weeds, where a large amount of grass clippings splash, resulting in a high probability of debris adhering to the lens body. In this case, the control assembly controls the drive assembly to drive the cleaning member to move relative to the lens body for cleaning the lens body at a relatively high preset frequency. In contrast, when the lawn mower is in the triggered state and performing a map construction task and a return-to-charge task, the probability of debris adhering to the lawn mower is relatively low. The control assembly then controls the drive assembly to drive the cleaning member to move relative to the lens body for cleaning at a relatively low preset frequency.

By differentially controlling the magnitude of the preset frequency, it allows dynamic adjustment of the automatic cleaning frequency of the lens body. This avoids excessive cleaning that would cause loss of the cleaning member and energy waste when the lens body is less likely to be contaminated, while ensuring timely removal of debris and maintaining surface cleanliness of the lens body when the lens body is more likely to be contaminated.

In some embodiments, the lens cleaning method for the lawn mower further includes: when the lawn mower needs to perform obstacle avoidance, performing an obstacle avoidance task synchronously during the controlling of the cleaning member to move relative to the lens body.

The obstacle avoidance task refers to controlling the lawn mower to perform a series of evasive actions upon detecting obstacles, so as to prevent collisions between the lawn mower and obstacles. The obstacle avoidance task aims to enable the lawn mower to actively bypass or turn around to avoid the obstacles, thereby reducing excessive user intervention and improving the user experience.

In the present embodiment, during performing the map construction task, the mowing task, or the return-to-charge task, if an obstacle is detected in the traveling direction of the lawn mower, the control assembly may control the lawn mower to perform obstacle avoidance. During or prior to the lawn mower performing the obstacle avoidance task, if the control assembly needs to control the drive assembly to drive the cleaning member to move relative to the lens body for cleaning the lens body, the control assembly controls the lawn mower to perform the obstacle avoidance task and the automatic cleaning task simultaneously, so as to avoid action conflicts.

It should be noted that in some embodiments, the lens cleaning method for the lawn mower further includes: during the moving of the cleaning member relative to the lens body, deactivating the lens body or controlling the lens body to stop outputting detection results. In the present embodiment, during the process that the control assembly controls the cleaning member to clean the lens body, the control assembly does not receive real-time images or videos collected by the lens body. This prevents the control assembly from mistakenly identifying the reciprocating movement of the cleaning member as an obstacle. During automatic cleaning, since the control assembly does not receive real-time images or videos from the lens body, it cannot perform obstacle recognition based on the images or videos collected by the lens body. At this time, the control assembly can perform obstacle recognition using other redundantly arranged sensing components on the lawn mower (such as radar, ultrasonic sensors, or other lens bodies provided at different positions), thereby fundamentally avoiding misidentifying the moving cleaning member arranged facing the current lens body as an obstacle.

The above lens cleaning method for the lawn mower avoids the control assembly making judgments based on incomplete or defective images or videos by deactivating the lens or stopping outputting detection results during the moving of the cleaning member relative to the lens body. This eliminates hidden dangers of missed or erroneous judgments from the source, prevents misidentification of the cleaning assembly, and ensures the accuracy of action execution.

In some embodiments, when controlling the cleaning member to move relative to the lens body for cleaning the lens body, includes: controlling the cleaning member to move relative to the lens body for a preset number of times at a preset cleaning cycle; the preset cleaning cycle includes an operation time period and a stop time period, the stop time period is set according to a preset duration, and the operation time period is shorter than the stop time period.

In the present embodiment, the control assembly can control the cleaning member to clean the surface of the lens body in the following sequence: first operation time, first stop time, second operation time, second stop time, …, n‑th operation time, n‑th stop time, where n represents the number of cycles.

The arrangement where the operation time is shorter than the stop time can be understood as follows: the moving speed of the cleaning member on the surface of the lens body is relatively high, such that the actual cleaning time, i.e., the operation time, is shorter than the stop time.

The above lens cleaning method for the lawn mower can reduce the possibility that automatic cleaning actions interfere with the field of view of the lens body based on a cyclical design of short operation time and long stop time. By completing cleaning within an extremely short time, the impact of the automatic cleaning process on the continuity of the ongoing work task of the lawn mower is minimized to the greatest extent. The long stop time ensures that the lawn mower focuses on performing its work task for most of the time, thereby improving the operational smoothness of the lawn mower and enhancing user experience.

In an embodiment, another lens cleaning method for the lawn mower is provided. The execution subject of the lens cleaning method may be a control assembly in the lawn mower, or a server corresponding to the lawn mower. The server is located in the cloud, is connected to the control assembly of the lawn mower via a network, and issues trigger instructions to the lawn mower, or forwards trigger instructions, which are sent by a user through a terminal communicatively connected to the lawn mower, to the lawn mower, and so on.

In this embodiment, the lens cleaning method being applied to the control assembly is taken as an example for illustration. As shown in FIG. 11, the lens cleaning method includes: step 602, when both the lawn mower and the lens body are activated, and when the contamination detection assembly detects that the contamination exists on the surface of the lens body, acquiring a working state of the lawn mower and a position of the lawn mower relative to a charging station, and determining whether to control the drive assembly to drive the cleaning member to move relative to the lens body for cleaning the lens body.

In the present embodiment, upon confirming that the lawn mower is activated and the lens body is in use, the control assembly further determines whether the contamination exists on the surface of the lens body. Only when a cleaning requirement is determined, the control assembly controls the drive assembly to drive the cleaning member to move relative to the lens body based on the working state of the lawn mower and the position of the lawn mower relative to the charging station.

The above lens cleaning method for the lawn mower can accurately detect contamination via the contamination detection assembly, thereby avoiding unnecessary cleaning. In cases where it is determined that the surface of the lens body requires cleaning, the cleaning strategy is dynamically adapted in combination with the working state of the lawn mower and the position of the lawn mower relative to the charging station. This not only ensures the cleaning effect but also avoids interfering with the normal operation of the lawn mower, thus reducing ineffective wear and tear on the lawn mower, achieving precise automatic cleaning, and optimizing the user experience.

In some embodiments, step 602 includes: when the lawn mower is in the trigger instruction receiving state, if the contamination detection assembly detects that the contamination exists on the surface of the lens body, acquiring the position of the lawn mower relative to the charging station, and controlling the drive assembly to drive the cleaning member to move relative to the lens body for cleaning the surface of the lens body.

In an embodiment, the work tasks include a mowing task, a map construction task and a return-to-charge task.

Specifically, the acquiring the position of the lawn mower relative to the charging station, and controlling the drive assembly to drive the cleaning member to move relative to the lens body for cleaning the surface of the lens body, includes: if the lawn mower is located outside the charging station, controlling the drive assembly to drive the cleaning member to move relative to the lens body for cleaning the lens body; after surface cleaning of the lens body is completed, controlling the lawn mower to perform the return-to-charge task, the map construction task or the mowing task; if the lawn mower is located inside the charging station and the trigger instruction is the map construction task or the mowing task, controlling the lawn mower to move away from the charging station for outgoing until the lawn mower is located outside the charging station, controlling the lawn mower to stop moving, and controlling the drive assembly to drive the cleaning member to move relative to the lens body for cleaning the lens body; after the surface cleaning of the lens body is completed, controlling the lawn mower to perform the map construction task or the mowing task.

In the present embodiment, when the contamination detection assembly detects that the contamination exists on the surface of the lens body, if the lawn mower is in the trigger instruction receiving state, that is, the lawn mower has received a trigger instruction and is in the stage of instruction parsing or waiting for execution, the control assembly then further determines the specific position of the lawn mower. If the lawn mower is located inside the charging station, the control assembly controls the lawn mower to perform an outgoing action; when the lawn mower moves outside the charging station, it stops moving, and the drive assembly is controlled to drive the cleaning member to move relative to the lens body. If the lawn mower is located outside the charging station, the control assembly directly controls the drive assembly to drive the cleaning member to move relative to the lens body, so as to complete automatic cleaning of the lens body.

When the contamination detection assembly detects that the contamination exists on the surface of the lens body, if the work task corresponding to the trigger instruction is the map construction task or the mowing task, the control assembly may determine that the lawn mower needs to subsequently perform work tasks outside the charging station. At this time, if the lawn mower is located inside the charging station, the control assembly controls the lawn mower to automatically perform an outgoing action until the lawn mower is located outside the charging station, then controls the lawn mower to stop moving, and controls the drive assembly to drive the cleaning member to move relative to the lens body for cleaning the lens body. However, if the work task corresponding to the trigger instruction is the return-to-charge task, that is, the lawn mower needs to subsequently return to the charging station, at this time, if the control assembly controls the lawn mower to perform the outgoing action, it will conflict with the user’s control intent. In this case, the control assembly may, for example, refrain from controlling the cleaning member to clean the lens body, and may further generate prompt information to remind the user that the lawn mower is currently located inside the charging station.

In the above lens cleaning method for the lawn mower, upon receiving a trigger instruction for the map construction task or the mowing task, if the lawn mower is currently located inside the charging station, the control assembly adopts a control logic of exiting the station first and then cleaning to perform automatic cleaning of the lens body. This avoids secondary contamination that the lens body is adhered with grass clippings and dust again during the subsequent process of moving out of the charging station after being cleaned inside the charging station. If the lawn mower is currently located outside the charging station, the control assembly directly controls the cleaning member to clean the lens body to ensure cleaning timeliness. Furthermore, after completing the outgoing action and automatic cleaning, the control assembly may automatically control the lawn mower to enter the triggered state and continue performing the work task corresponding to the trigger instruction. On the premise of ensuring the continuity and timeliness of the lawn mower in performing work tasks, the lens body is kept clean at all times, thereby improving the practicality of the lawn mower.

In some embodiments, the lens cleaning method for the lawn mower further includes: during that the lawn mower performs the map construction task or the mowing task, if the contamination detection assembly detects that the contamination does not exists on the surface of the lens body, controlling the lawn mower to move at an initial moving speed; if the contamination detection assembly detects that the contamination exists on the surface of the lens body, controlling the drive assembly to drive the cleaning member to move relative to the lens body, and during the moving of the cleaning member, controlling the lawn mower to move at a preset moving speed; the preset moving speed is lower than the initial moving speed.

The initial moving speed refers to a default moving speed adopted by the lawn mower during performing the work task. Under normal circumstances, the initial moving speed is relatively high.

To avoid collisions that may occur when the lawn mower moves too fast during performing the cleaning action on the lens body, the preset moving speed is lower than the initial moving speed, thereby improving the operational safety of the lawn mower.

When the lawn mower enters the triggered state, it first moves at the initial moving speed to perform the corresponding work task. At the same time, the contamination detection assembly starts real-time detection. If the contamination is detected on the surface of the lens body, the control assembly controls the drive assembly to drive the cleaning member to move relative to the lens body. During performing the surface cleaning of the lens body by the cleaning member, the control assembly may simultaneously adjust the moving speed of the lawn mower so that it moves at a preset speed. After the control assembly controls the cleaning member to complete the surface cleaning of the lens body, the control assembly then adjusts the moving speed of the lawn mower back to the initial moving speed.

During performing the work task, the contamination detection assembly continuously performs contamination detection until the lawn mower finishes the work task.

With the above lens cleaning method for the lawn mower, when contamination is detected on the surface of the lens body, the control assembly can synchronously control the lawn mower to reduce its moving speed, allowing the lawn mower to operate stably at a low speed. This avoids uneven friction between the cleaning member and the lens caused by high-speed movement, enables the cleaning member to snugly fit to the lens surface, and accurately removes debris such as grass clippings and loose dust, thus improving cleaning thoroughness. Meanwhile, this prevents violent collisions between the high-speed moving lawn mower and obstacles, enhancing the operational safety of the lawn mower. When there is no contamination on the surface of the lens body, the control assembly can control the lawn mower to maintain at the initial moving speed, thereby ensuring the working efficiency of the map construction task or the mowing task and avoiding impacts on work progress caused by unnecessary speed reduction.

In some embodiments, the lens cleaning method for the lawn mower further includes: during that the lawn mower perform the return-to-charge task, controlling the lawn mower to move along a return-to-charge path corresponding to the return-to-charge task for performing the return-to-charge task.

The return-to-charge task refers to a task in which the lawn mower moves toward the charging station and performs charging. The trigger instruction corresponding to the return-to-charge task may, for example, be automatically generated by the control assembly when detecting that the real-time battery level of the lawn mower falls below a preset battery threshold, or may be manually sent by the user after checking the real-time battery level of the lawn mower via a terminal.

The return-to-charge path refers to a moving trajectory to the charging station obtained by performing path planning based on the current position of the lawn mower and the position of the charging station.

In an embodiment, if the lawn mower encounters an obstacle during performing the return-to-charge task, the control assembly may, for example, generate prompt information to remind the user to remove the obstacle. The prompt information may be displayed through the terminal, or by means of prompt tones, light or the like emitted by the body of the lawn mower. At the same time, the control assembly may control the lawn mower to stop moving temporarily until the obstacle is removed, and then continue moving along the return-to-charge path.

If the obstacle is still not removed within a preset duration, the control assembly may, for example, control the lawn mower to adjust its posture to bypass the obstacle within the range of the return-to-charge path. If the lawn mower cannot avoid the obstacle by adjusting its position within the return-to-charge path, the control assembly may automatically activate local path bypass planning to control the lawn mower to bypass the obstacle and then quickly return to the return-to-charge path and continue performing the return-to-charge task.

Alternatively, if the lawn mower encounters the obstacle during performing the return-to-charge task, the control assembly may preferentially perform the local path bypass planning to actively bypass the obstacle. This ensures a high degree of intelligence of the lawn mower during use, avoids excessive user intervention, and improves the user experience.

Further, in some embodiments, the lens cleaning method for the lawn mower further includes: during the moving of the lawn mower along the return-to-charge path, if the contamination detection assembly detects that the contamination exists on the surface of the lens body, controlling the lawn mower to move to a preset position and stop moving; the preset position is on the return-to-charge path; controlling the drive assembly to drive the cleaning member to move relative to the lens body for cleaning the lens body; after the surface cleaning of the lens body is completed, controlling the lawn mower to continue moving along the return-to-charge path so as to continue performing the return-to-charge task.

The preset position refers to a coordinate point marked in advance on the return-to-charge path, and the position corresponding to the coordinate point is located before the charging station. When the lawn mower is at the preset position, it can face the charging station, and the lens body can collect front image information of the charging station, so as to determine the precise position of the charging station, adjust the posture of the lawn mower accordingly, and ensure that the lawn mower enters the charging station smoothly.

In the present embodiment, during the moving of the lawn mower along the return-to-charge path, if the control assembly detects that the contamination exists on the surface of the lens body, it will not immediately control the cleaning member to perform cleaning. Since contamination on the surface of the lens body during the return-to-charge is mostly loose dust or slight grass clippings, which will not immediately cause failure of path tracking of the lawn mower, and thus there is no need to interrupt the return-to-charge task to clean the surface of the lens body. This prevents the automatic cleaning of the lawn mower from hindering the execution of the recharging task and avoids delaying recharging due to excessive cleaning of the lens body.

After the lawn mower moves to the preset position, the control assembly controls the lawn mower to stop moving, and then controls the drive assembly to drive the cleaning member to move relative to the lens body for cleaning the lens body, so that the lens body can be kept clean before entering the charging station for charging.

The above lens cleaning method for the lawn mower can prioritize the performing efficiency of the return-to-charge task during performing the return-to-charge task, and restrict the cleaning action on the lens body to being performed at the preset position. Thus, dual guarantees of the cleaning effect of the lens body on the lawn mower and the reliability of the return-to-charge can be achieved.

In some embodiments, step 602 includes: when the lawn mower is in the standby state, and when the contamination detection assembly detects that the contamination exists on the surface of the lens body, determining whether to control the drive assembly to drive the cleaning member to move relative to the lens body for cleaning the surface of the lens body based on the position of the lawn mower relative to the charging station.

Specifically, if the lawn mower is located outside the charging station, the drive assembly is controlled to drive the cleaning member to move relative to the lens body for cleaning the lens body; if the lawn mower is located inside the charging station, automatic cleaning of the lens body is not performed.

In the present embodiment, when the contamination detection assembly detects that the contamination exists on the surface of the lens body, if the lawn mower is in the standby state, the control assembly may further determine the specific position of the lawn mower. If the lawn mower is located inside the charging station, the drive assembly is controlled to drive the cleaning member to move relative to the lens body at this time, this may cause a collision between the cleaning member and the charging station. In addition, the lawn mower is not performing any specific work task at this moment, so there is no need to ensure the visual navigation accuracy, obstacle avoidance effect and operation integrity of the lawn mower, and even if the contamination adheres to the surface of the lens body, it will not affect the operation of the lawn mower. Furthermore, if the lawn mower needs to perform a specific work task later, the cleaned lens body may still be re-contaminated during performing the outgoing action, making it difficult to maintain the effect of automatic cleaning inside the charging station. Besides, after the lawn mower completes the outgoing task, it will perform an automatic cleaning operation to drive the cleaning member to move relative to the lens body. Therefore, automatic cleaning of the lens body inside the charging station is unnecessary, and the control assembly directly controls the drive assembly not to drive the cleaning assembly, i.e., no cleaning is performed on the lens body. If the lawn mower is located outside the charging station, the control assembly may directly control the drive assembly to drive the cleaning member to move relative to the lens body, so as to complete automatic cleaning of the lens body.

It should be noted that if the lawn mower is in the standby state and is located outside the charging station, after the control assembly controls the drive assembly to drive the cleaning member to complete one-time automatic cleaning of the lens body, the control assembly may continue to control the drive assembly to drive the cleaning member to move relative to the lens body according to the above control logic if the contamination detection assembly detects the contamination on the surface of the lens body again, so as to realize subsequent multiple-time automatic cleaning of the lens body. In this scenario, the lawn mower is located outside the charging station and has a high probability of being adhered with grass clippings, dust, mud and other debris, resulting in blurred or even invalid lens imaging. Through real-time judgment of the contamination condition on the surface of the lens body, automatic cleaning can be carried out in a timely manner when the contamination is detected, thereby preventing stains from adhering to the surface of the lens body while the lawn mower is waiting outside the charging station, which would otherwise affect the clarity of subsequent images or videos collected by the lens body.

The above lens cleaning method for the lawn mower can, upon detecting the contamination on the surface of the lens body, further perform automatic cleaning only when the lawn mower is in the standby state and located outside the charging station based on the working state of the lawn mower and the position of the lawn mower relative to the charging station, so as to avoid contamination risks in complex outdoor environments. When the lawn mower is in the standby state and located inside the charging station, if the drive assembly is controlled to drive the cleaning member to move relative to the lens body, it may cause a collision between the cleaning member and the charging station. In addition, the lawn mower is not performing any specific work task at this moment, so there is no need to ensure the visual navigation accuracy, obstacle avoidance effect and operation integrity of the lawn mower. Even if the contamination adheres to the surface of the lens body, it will not affect the operation of the lawn mower. Furthermore, if the lawn mower needs to perform a specific work task later, the cleaned lens body may still suffer secondary contamination during performing outgoing action, making it difficult to maintain the effect of automatic cleaning inside the charging station. In addition, after the lawn mower completes the outgoing task, it will perform an automatic cleaning operation, the drive assemble is controlled to drive the cleaning member to move relative to the lens body. Therefore, automatic cleaning of the lens body inside the charging station is unnecessary, so the cleaning action is not activated, avoiding ineffective consumption and saving energy.

In some embodiments, after determining to control the drive assembly to drive the cleaning member to move relative to the lens body for cleaning the lens body, the method further includes: when the contamination detection assembly detects that the contamination still exists on the surface of the lens body, controlling the cleaning member to move relative to the lens body for a preset duration; and when the contamination still exists on the surface of the lens body, deactivating the lens body or controlling the lens body to stop outputting detection results, controlling the cleaning member to reset, and controlling the lawn mower to continue working.

During the process in which the drive assembly is controlled to drive the cleaning member to move relative to the lens body for cleaning the lens body, the duration of moving of the cleaning member relative to the lens body is shorter than the preset duration. This enables that the cleaning member is controlled to perform longer and more thorough cleaning when the contamination detection assembly detects stubborn stains on the surface of the lens body.

It should be noted that, in the case where the contamination detection assembly detects that the contamination still exists on the surface of the lens body, the control assembly may also limit the number of reciprocating movements of the cleaning member relative to the lens body.

Alternatively, in an embodiment, when the contamination detection assembly detects that the contamination still exists on the surface of the lens body, the control assembly controls the cleaning member to move relative to the lens body for a preset duration according to a preset number of times. If the contamination still exists on the surface of the lens body and the number of times that the control assembly has controlled the cleaning member to move relative to the lens body for the preset duration reaches the preset number of times, the control assembly then deactivates the lens body or controls the lens body to stop outputting detection results, controls the cleaning member to reset, and controls the lawn mower to continue working.

The above lens cleaning method for the lawn mower can add a cleaning step of a preset duration for situations where basic automatic cleaning fails to meet the standard. The control assembly can effectively remove lightly adhered contamination by extending the cleaning time of the cleaning member, preventing unclear images or videos subsequently collected by the lens body due to incomplete one-time cleaning. If the contamination still remains on the surface of the lens body after repeated cleaning, the control assembly can directly deactivate the lens body or control the lens body to stop outputting detection results, thereby abandoning automatic cleaning and avoiding continuous ineffective friction against stubborn stains. Meanwhile, the cleaning member is controlled to reset, ensuring the lens body is not physically blocked and leaving room for possible automatic recovery later, while allowing the lawn mower to continue performing the work task. This prioritizes the normal operation of the lawn mower and improves user experience.

Further, in an embodiment, after deactivating the lens body, the method further includes: generate prompt information to prompt a user that the contamination detection assembly of the lawn mower is abnormal or the cleaning member is not capable of completing automatic cleaning of the lens body.

The prompt information in the present embodiment is configured to indicate that there are stubborn stains on the surface of the lens body that cannot be removed by automatic cleaning, or that the contamination detection assembly is faulty and cannot normally determine whether the contamination exists on the surface of the lens body.

The above lens cleaning method for the lawn mower sends prompt information to the user to remind the user to perform manual maintenance, such as wiping the surface of the lens body, replacing the cleaning member, or inspecting and repairing the contamination detection assembly. This ensures that information about abnormal conditions such as stubborn contamination on the lens body, failure of automatic cleaning, or equipment faults are promptly communicated to the user, avoiding accumulation of equipment problems of the lawn mower. Meanwhile, this enables timely handling of lawn mower faults, guarantees human-computer interaction efficiency, and improves user experience.

When the cleaning assembly of the lawn mower performs a cleaning action on the lens body, the cleaning assembly moves back and forth relative to the surface of the lens body, which inevitably blocks part of the field of view of the lens body. This may result in black or blurred bands in images or videos collected by the lens body. If there are obstacles in the working area corresponding to the lawn mower and the obstacles happen to be in the area blocked by the black or blurred bands, the lawn mower may fail to timely identify and avoid the obstacles. At the same time, the moving of the cleaning assembly may also be misjudged by the lawn mower as moving obstacles, causing the lawn mower to perform incorrect obstacle avoidance actions and resulting in abnormal operation execution of the lawn mower.

In response to the above problems, the lens cleaning method for the lawnmower in the present application may further provide the following technical solution to solve the technical problem that the cleaning member hinders obstacle recognition of the lens body during cleaning the lens body.

In some embodiments, the lens cleaning method for the lawnmower further includes: when the lawn mower needs to perform obstacle avoidance, performing an obstacle avoidance task synchronously during the controlling of the cleaning member to move relative to the lens body.

The obstacle avoidance task refers to controlling the lawn mower to perform a series of evasive actions upon detecting obstacles, so as to prevent collisions between the lawn mower and obstacles. The obstacle avoidance task aims to enable the lawn mower to actively bypass obstacles or turn around to avoid the obstacles, thereby reducing excessive user intervention and improving the user experience.

In the present embodiment, during performing the return-to-charge task, the map construction task or the mowing task, if an obstacle is detected in the traveling direction of the lawn mower, the control assembly may control the lawn mower to perform the obstacle avoidance. During or prior to the lawn mower performing the obstacle avoidance task, if the control assembly needs to control the drive assembly to drive the cleaning member to move relative to the lens body for cleaning the lens body, the control assembly controls the lawn mower to perform the obstacle avoidance task and the automatic cleaning task simultaneously, so as to avoid action conflicts.

It should be noted that in some embodiments, the lens cleaning method for the lawn mower further includes: during the moving of the cleaning member relative to the lens body, deactivating the lens body or controlling the lens body to stop outputting detection results.

In the present embodiment, during the process that the control assembly controls the cleaning member to clean the lens body, the control assembly does not receive real-time images or videos collected by the lens body. This prevents the control assembly from mistakenly identifying the reciprocating movement of the cleaning member as an obstacle. During automatic cleaning, since the control assembly does not receive real-time images or videos from the lens body, it cannot perform obstacle recognition based on the images or videos collected by the lens body. At this time, the control assembly can perform obstacle recognition using other redundantly arranged sensing components on the lawn mower (such as radar, ultrasonic sensors, or other lens bodies provided at different positions), thereby fundamentally avoiding misidentifying the moving cleaning member arranged facing the current lens body as an obstacle.

The above lens cleaning method for the lawn mower avoids the control assembly making judgments based on incomplete or defective images or videos by deactivating the lens or stopping the output of detection results during the moving of the cleaning member relative to the lens body. This eliminates hidden dangers of missed or erroneous judgments from the source, prevents misidentification of the cleaning assembly, and ensures the accuracy of action execution.

In some embodiments, controlling the cleaning member to move relative to the lens body for cleaning the lens body, includes: controlling the cleaning member to move relative to the lens body for a preset number of times at a preset cleaning cycle;

the preset cleaning cycle includes an operation time period and a stop time period, the stop time period is set according to a preset duration, and the operation time period is shorter than the stop time period.

In the present embodiment, the control assembly can control the cleaning member to clean the surface of the lens body in the following sequence: first operation time, first stop time, second operation time, second stop time, …, n‑th operation time , n‑th stop time, where n represents the number of cycles.

The arrangement where the operation time is shorter than the stop time can be understood as follows: the moving speed of the cleaning member on the surface of the lens body is relatively high, such that the actual cleaning time, i.e., the operation time, is shorter than the stop time.

The above lens cleaning method for the lawn mower can reduce the possibility that automatic cleaning actions interfere with the field of view of the lens body based on a cyclical design of short operation time and long stop time. By completing cleaning within an extremely short time, the impact of the automatic cleaning process on the continuity of the ongoing work task of the lawn mower is minimized to the greatest extent. The long stop time ensures that the lawn mower focuses on performing its work task for most of the time, thereby improving the operational smoothness of the lawn mower and enhancing user experience.

It should be understood that although the steps in the flowcharts involved in the above embodiments are displayed sequentially as indicated by the arrows, these steps are not necessarily executed in the order indicated by the arrows. Unless explicitly stated herein, the execution of these steps is not subject to strict sequential restrictions, and these steps may be executed in other orders. Moreover, at least some of the steps in the flowcharts involved in the above embodiments may include multiple steps or multiple stages. These steps or stages are not necessarily executed and completed at the same time, but may be executed at different times. The execution order of these steps or stages is also not necessarily sequential; instead, they may be executed alternately or in turn with other steps or at least part of the steps or stages in other steps.

Based on the same inventive concept, embodiments of the present application further provide a lens cleaning device for a lawn mower for implementing the above lens cleaning method for the lawn mower. The solution to the problem provided by the lens cleaning device for the lawn mower is similar to the solution described in the above lens cleaning method for the lawn mower. Therefore, for specific limitations in one or more of the device embodiments provided below, reference may be made to the limitations on the lens cleaning method for the lawn mower in the foregoing text, which will not be repeated here.

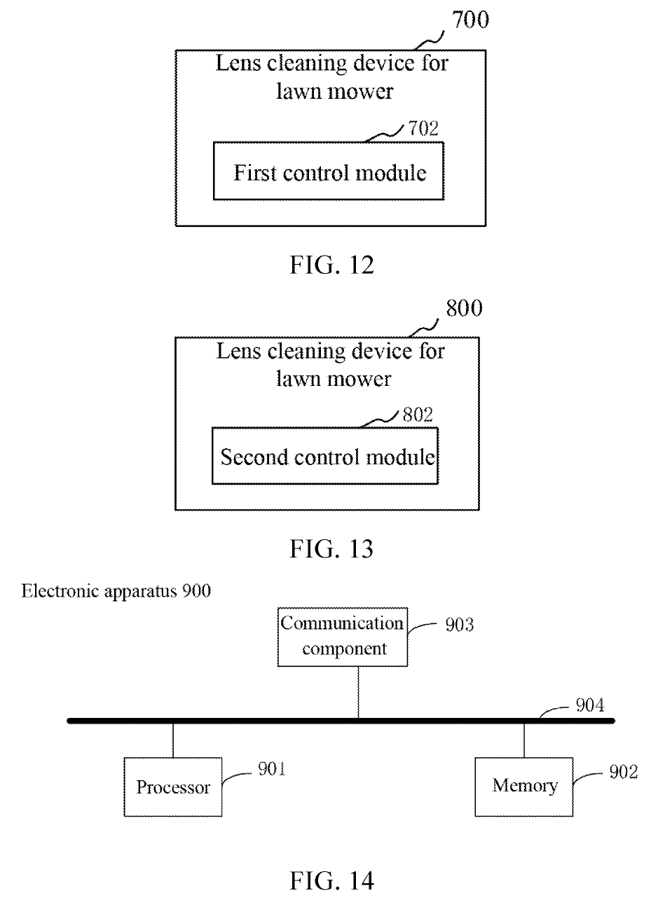

In an embodiment, as shown in FIG. 12, a lens cleaning device 700 for a lawnmower is provided, which includes: a first control module 702, configured to when both the lawn mower and the lens body are activated, acquire a working state of the lawn mower and a position of the lawn mower relative to a charging station, and determine whether to control the drive assembly to drive the cleaning member to move relative to the lens body for cleaning the lens body.

In some embodiments, the first control module 702 is further configured to: when the lawn mower is in the trigger instruction receiving state and is located outside the charging station, control the drive assembly to drive the cleaning member to move relative to the lens body for cleaning the lens body; after surface cleaning of the lens body is completed, control the lawn mower to perform the work task; when the lawn mower is in the trigger instruction receiving state and is located inside the charging station, control the lawn mower to move away from the charging station for outgoing until the lawn mower is located outside the charging station, control the lawn mower to stop moving, and control the drive assembly to drive the cleaning member to move relative to the lens body for cleaning the lens body; after the surface cleaning of the lens body is completed, control the lawn mower to perform the work task; when the lawn mower is in the standby state and is located outside the charging station, control the drive assembly to drive the cleaning member to move relative to the lens body for cleaning the lens body; when the lawn mower is in the standby state and is located inside the charging station, control the cleaning assembly not to perform cleaning.

In some embodiments, the first control module 702 is further configured to: when the lawn mower is in the triggered state, control the drive assembly to drive the cleaning member to move relative to the lens body for cleaning the lens body at a preset frequency.

In an embodiment, as shown in FIG. 13, a lens cleaning device 800 for a lawnmower is provided, which includes: a second control module 802, configured to when both the lawn mower and the lens body are activated, and when the contamination detection assembly detects that the contamination exists on the surface of the lens body, acquire a working state of the lawn mower and a position of the lawn mower relative to a charging station, and determine whether to control the drive assembly to drive the cleaning member to move relative to the lens body for cleaning the lens body.

In some embodiments, the second control module 802 is further configured to: when the lawn mower is in the trigger instruction receiving state, if the contamination detection assembly detects that the contamination exists on the surface of the lens body, acquire the position of the lawn mower relative to the charging station, and control the drive assembly to drive the cleaning member to move relative to the lens body for cleaning the surface of the lens body.

In some embodiments, the second control module 802 is further configured to: if the lawn mower is located outside the charging station, control the drive assembly to drive the cleaning member to move relative to the lens body for cleaning the lens body; after surface cleaning of the lens body is completed, control the lawn mower to perform the return-to-charge task, the map construction task or the mowing task; if the lawn mower is located inside the charging station and the trigger instruction is the map construction task or the mowing task, control the lawn mower to move away from the charging station for outgoing until the lawn mower is located outside the charging station, control the lawn mower to stop moving, and controlling the drive assembly to drive the cleaning member to move relative to the lens body for cleaning the lens body; after the surface cleaning of the lens body is completed, control the lawn mower to perform the map construction task or the mowing task.

In some embodiments, the second control module 802 is further configured to: during that the lawn mower performs the map construction task or the mowing task, if the contamination detection assembly detects that the contamination does not exist on the surface of the lens body, control the lawn mower to move at an initial moving speed; if the contamination detection assembly detects that the contamination exists on the surface of the lens body, control the drive assembly to drive the cleaning member to move relative to the lens body, and during the moving of the cleaning member, control the lawn mower to move at a preset moving speed; the preset moving speed is lower than the initial moving speed.

In some embodiments, the second control module 802 is further configured to: during that the lawn mower perform the return-to-charge task, control the lawn mower to move along a return-to-charge path corresponding to the return-to-charge task for performing the return-to-charge task.

In some embodiments, the second control module 802 is further configured to: during the moving of the lawn mower along the return-to-charge path, if the contamination detection assembly detects that the contamination exists on the surface of the lens body, control the lawn mower to move to a preset position and stop moving; the preset position is on the return-to-charge path; control the drive assembly to drive the cleaning member to move relative to the lens body for cleaning the lens body; after the surface cleaning of the lens body is completed, control the lawn mower to continue moving along the return-to-charge path so as to continue performing the return-to-charge task.

In some embodiments, the second control module 802 is further configured to: when the lawn mower is in the standby state, and when the contamination detection assembly detects that the contamination exists on the surface of the lens body, determine whether to control the drive assembly to drive the cleaning member to move relative to the lens body for cleaning the surface of the lens body based on the position of the lawn mower relative to the charging station.

In some embodiments, the second control module 802 is further configured to: if the lawn mower is located outside the charging station, control the drive assembly to drive the cleaning member to move relative to the lens body for cleaning the lens body; if the lawn mower is located inside the charging station, not perform automatic cleaning of the lens body.

In some embodiments, the second control module 802 is further configured to: when the contamination detection assembly detects that the contamination still exists on the surface of the lens body, control the cleaning member to move relative to the lens body for a preset duration; and when the contamination still exists on the surface of the lens body, deactivate the lens body or controlling the lens body to stop outputting detection results, control the cleaning member to reset, and control the lawn mower to continue working.

In some embodiments, the second control module 802 is further configured to: generate prompt information to prompt a user that the contamination detection assembly of the lawn mower is abnormal or the cleaning member is not capable of completing automatic cleaning of the lens body.

In some embodiments, the second control module 802 is further configured to: when the lawn mower needs to perform obstacle avoidance, perform an obstacle avoidance task synchronously during the controlling of the cleaning member to move relative to the lens body.

In some embodiments, the second control module 802 is further configured to:

control the cleaning member to move relative to the lens body for a preset number of times at a preset cleaning cycle;

the preset cleaning cycle includes an operation time period and a stop time period, the stop time period is set according to a preset duration, and the operation time period is shorter than the stop time period.

In some embodiments, the second control module 802 is further configured to: during the moving of the cleaning member relative to the lens body, deactivate the lens body or stop outputting detection results.

All or part of the modules in the above device may be implemented by software, hardware, or a combination thereof. Each of the above modules may be embedded in or independent of a processor in a computer device in the form of hardware, or stored in a memory in a computer device in the form of software, so that the processor invokes and executes operations corresponding to the above modules.

FIG. 14 is a schematic structural diagram of an electronic apparatus provided in the present application. As shown in FIG. 14, an electronic apparatus 900 provided in the present embodiment includes: at least one processor 901 and a memory 902. In an embodiment, the apparatus 900 further includes a communication component 903. The processor 901, the memory 902, and the communication component 903 are connected via a bus 904.

In a specific implementation, the at least one processor 901 executes computer-executable instructions stored in the memory 902, so that the at least one processor 901 performs the above method.

For the specific implementation of the processor 901, reference may be made to the above method embodiments, whose implementation principles and technical effects are similar, and details are not described herein again in this embodiment.

In the above embodiments, it should be understood that the processor may be a central processing unit (CPU), or other general-purpose processors, a digital signal processor (DSP), an application specific integrated circuit (ASIC), and the like. A general-purpose processor may be a microprocessor or any conventional processor. The steps of the methods disclosed in connection with the application may be directly embodied as being implemented by a hardware processor, or implemented by a combination of hardware and software modules in the processor.

The memory may include a high-speed random access memory (RAM), and may also include a non-volatile memory (NVM), such as at least one disk memory.

The bus may be an industry standard architecture (ISA) bus, a peripheral component interconnect (PCI) bus, an extended industry standard architecture (EISA) bus, or the like. Buses may be classified as address buses, data buses, control buses, and so forth. For ease of representation, the buses in the drawings of the present application are not limited to only one bus or one type of bus.

The present application further provides a computer program product, which includes a computer program, the above method is implemented when the computer program is executed by a processor.

The present application further provides a computer-readable storage medium having stored therein computer-executable instructions, the above method is implemented when the computer-executable instructions are executed by a processor.

The above readable storage medium may be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk. A readable storage medium may be any available medium that can be accessed by a general-purpose or a special-purpose computer.

An exemplary readable storage medium is coupled to a processor to enable the processor to read information from, and write information to, the readable storage medium. Of course, the readable storage medium may also be an integral part of a processor. The processor and the readable storage medium may be located in an application specific integrated circuit (ASIC). Of course, the processor and the readable storage medium may also reside as discrete components in a device.

The division of units is merely a logical functional division, and other divisions may be adopted in actual implementation, for example, multiple units or components may be combined or integrated into another system, or some features may be omitted or not implemented. In addition, the mutual coupling, direct coupling, or communication connection shown or discussed may be indirect coupling or communication connection through some interfaces, devices, or units, and may be in electrical, mechanical, or other forms.

Units described as separate components may or may not be physically separate, and components shown as units may or may not be physical units, that is, they may be located in one place or distributed over multiple network units. Some or all of the units may be selected according to actual needs to achieve the objectives of the solutions of the present embodiments.

In addition, respective functional units in respective embodiments of the present application may be integrated into one processing unit, or respective units may exist physically alone, or two or more units may be integrated into one unit.

If functions are implemented in the form of software functional units and sold or used as independent products, they may be stored in a computer-readable storage medium. Based on such understanding, the technical solutions of the present application, essentially, or the parts thereof that contribute to the prior art, may be embodied in the form of a software product stored in a storage medium, including a number of instructions for causing a computer device (which may be a personal computer, a server, a network device, or the like) to perform all or part of the steps of the methods described in the various embodiments of the present application. The aforementioned storage medium includes: a U disk, a removable hard disk, a read-only memory (ROM), a random access memory (RAM), a magnetic disk, an optical disk, and other media that can store program codes.

The person skilled in the art may understand that all or part of the steps of the foregoing method embodiments may be implemented by hardware related to program instructions. The foregoing program may be stored in a computer-readable storage medium. When the program is executed, the steps including the foregoing method embodiments are implemented; and the foregoing storage medium includes: ROM, RAM, a magnetic disk, an optical disk, and other media that can store program codes.

Finally, it should be noted that the person skilled in the art will readily conceive of other embodiments of the present application upon consideration of the specification and practice of the application disclosed herein. The present application is intended to cover any variations, uses, or adaptations of the application that follow its general principles and include common general knowledge or conventional technical means in the art that are not disclosed herein, and is not limited to the precise structure described above and shown in the drawings, and various modifications and changes may be made without departing from the scope thereof. The scope of the application is limited only by the appended claims.

What is claimed is:

1. A lens cleaning method for a lawn mower, wherein the lawn mower comprises a vision assembly, a drive assembly and a cleaning assembly;
the vision assembly comprises a lens body;
a cleaning member is provided on a side of the cleaning assembly facing the lens body;
the drive assembly is connected to the cleaning member and is configured to drive the cleaning member to move relative to the lens body for cleaning the lens body;
the method comprises:
when both the lawn mower and the lens body are activated, acquiring a working state of the lawn mower and a position of the lawn mower relative to a charging station, and determining whether to control the drive assembly to drive the cleaning member to move relative to the lens body for cleaning the lens body;
the working state comprises a trigger instruction receiving state, a triggered state and a standby state;
wherein the triggered state is a state of performing a work task corresponding to a trigger instruction;
the standby state is a state in which the lawn mower is activated and does not receive the trigger instruction, or in which the lawn mower has completed a previous work task and does not receive a new trigger instruction;
the position of the lawn mower relative to the charging station comprises that the lawn mower is located inside the charging station or outside the charging station.

2. The lens cleaning method according to claim 1, wherein the acquiring the working state of the lawn mower and the position of the lawn mower relative to the charging station, and determining whether to control the drive assembly to drive the cleaning member to move relative to the lens body for cleaning the lens body, comprises:
when the lawn mower is in the trigger instruction receiving state and is located outside the charging station, controlling the drive assembly to drive the cleaning member to move relative to the lens body for cleaning the lens body; after surface cleaning of the lens body is completed, controlling the lawn mower to perform the work task;
when the lawn mower is in the trigger instruction receiving state and is located inside the charging station, controlling the lawn mower to move away from the charging station for outgoing until the lawn mower is located outside the charging station, controlling the lawn mower to stop moving, and controlling the drive assembly to drive the cleaning member to move relative to the lens body for cleaning the lens body; after the surface cleaning of the lens body is completed, controlling the lawn mower to perform the work task;
when the lawn mower is in the standby state and is located outside the charging station, controlling the drive assembly to drive the cleaning member to move relative to the lens body for cleaning the lens body;
when the lawn mower is in the standby state and is located inside the charging station, controlling the cleaning assembly not to perform cleaning.

3. The lens cleaning method according to claim 2, wherein the acquiring the working state of the lawn mower and the position of the lawn mower relative to the charging station, and determining whether to control the drive assembly to drive the cleaning member to move relative to the lens body for cleaning the lens body, further comprises:
when the lawn mower is in the triggered state, controlling the drive assembly to drive the cleaning member to move relative to the lens body for cleaning the lens body at a preset frequency.

4. A lens cleaning method for a lawn mower, wherein the lawn mower comprises a vision assembly, a drive assembly, a cleaning assembly and a contamination detection assembly;
the vision assembly comprises a lens body;
a cleaning member is provided on a side of the cleaning assembly facing the lens body;
the drive assembly is connected to the cleaning member and is configured to drive the cleaning member to move relative to the lens body for cleaning the lens body;
the contamination detection assembly is in communication connection with the lens body and is configured to detect a contamination condition on a surface of the lens body when the lens body is activated;
the method comprises:
when both the lawn mower and the lens body are activated, and when the contamination detection assembly detects that contamination exists on the surface of the lens body, acquiring a working state of the lawn mower and a position of the lawn mower relative to a charging station, and determining whether to control the drive assembly to drive the cleaning member to move relative to the lens body for cleaning the lens body;
the working state comprises a trigger instruction receiving state, a triggered state and a standby state;
wherein the triggered state is a state of performing a return-to-charge task, a map construction task or a mowing task corresponding to a trigger instruction;
the standby state is a state in which the lawn mower is activated and does not receive the trigger instruction, or in which the lawn mower has completed a previous work task and does not receive a new trigger instruction;
the position of the lawn mower relative to the charging station comprises that the lawn mower is located inside the charging station or outside the charging station.

5. The lens cleaning method according to claim 4, wherein the when the contamination detection assembly detects that the contamination exists on the surface of the lens body, acquiring the working state of the lawn mower and the position of the lawn mower relative to the charging station, and determining whether to control the drive assembly to drive the cleaning member to move relative to the lens body for cleaning the lens body, comprises:
when the lawn mower is in the trigger instruction receiving state, if the contamination detection assembly detects that the contamination exists on the surface of the lens body, acquiring the position of the lawn mower relative to the charging station, and controlling the drive assembly to drive the cleaning member to move relative to the lens body for cleaning the surface of the lens body.

6. The lens cleaning method according to claim 5, wherein the acquiring the position of the lawn mower relative to the charging station, and controlling the drive assembly to drive the cleaning member to move relative to the lens body for cleaning the surface of the lens body, comprises:
if the lawn mower is located outside the charging station, controlling the drive assembly to drive the cleaning member to move relative to the lens body for cleaning the lens body; after surface cleaning of the lens body is completed, controlling the lawn mower to perform the return-to-charge task, the map construction task or the mowing task;
if the lawn mower is located inside the charging station and the trigger instruction is the map construction task or the mowing task, controlling the lawn mower to move away from the charging station for outgoing until the lawn mower is located outside the charging station, controlling the lawn mower to stop moving, and controlling the drive assembly to drive the cleaning member to move relative to the lens body for cleaning the lens body; after the surface cleaning of the lens body is completed, controlling the lawn mower to perform the map construction task or the mowing task.

7. The lens cleaning method according to claim 6, wherein the method further comprises:
during that the lawn mower performs the map construction task or the mowing task, if the contamination detection assembly detects that the contamination does not exist on the surface of the lens body, controlling the lawn mower to move at an initial moving speed; if the contamination detection assembly detects that the contamination exists on the surface of the lens body, controlling the drive assembly to drive the cleaning member to move relative to the lens body, and during the moving of the cleaning member, controlling the lawn mower to move at a preset moving speed;
the preset moving speed is lower than the initial moving speed.

8. The lens cleaning method according to claim 6, wherein the method further comprises:
during that the lawn mower perform the return-to-charge task, controlling the lawn mower to move along a return-to-charge path corresponding to the return-to-charge task for performing the return-to-charge task.

9. The lens cleaning method according to claim 8, wherein the method further comprises:
during the moving of the lawn mower along the return-to-charge path, if the contamination detection assembly detects that the contamination exists on the surface of the lens body, controlling the lawn mower to move to a preset position and stop moving; the preset position is on the return-to-charge path;
controlling the drive assembly to drive the cleaning member to move relative to the lens body for cleaning the lens body;
after the surface cleaning of the lens body is completed, controlling the lawn mower to continue moving along the return-to-charge path so as to continue performing the return-to-charge task.

10. The lens cleaning method according to claim 4, wherein the when the contamination detection assembly detects that the contamination exists on the surface of the lens body, acquiring the working state of the lawn mower and the position of the lawn mower relative to the charging station, and determining whether to control the drive assembly to drive the cleaning member to move relative to the lens body for cleaning the lens body, comprises:
when the lawn mower is in the standby state, and when the contamination detection assembly detects that the contamination exists on the surface of the lens body, determining whether to control the drive assembly to drive the cleaning member to move relative to the lens body for cleaning the surface of the lens body based on the position of the lawn mower relative to the charging station.

11. The lens cleaning method according to claim 10, wherein the determining whether to control the drive assembly to drive the cleaning member to move relative to the lens body for cleaning the surface of the lens body based on the position of the lawn mower relative to the charging station, comprises:
if the lawn mower is located outside the charging station, controlling the drive assembly to drive the cleaning member to move relative to the lens body for cleaning the lens body;
if the lawn mower is located inside the charging station, not performing automatic cleaning of the lens body.

12. The lens cleaning method according to claim 4, wherein after the determining to control the drive assembly to drive the cleaning member to move relative to the lens body for cleaning the lens body, the method further comprises:
when the contamination detection assembly detects that the contamination still exists on the surface of the lens body, controlling the cleaning member to move relative to the lens body for a preset duration; and when the contamination still exists on the surface of the lens body, deactivating the lens body or controlling the lens body to stop outputting detection results, controlling the cleaning member to reset, and controlling the lawn mower to continue working.

13. The lens cleaning method according to claim 11, wherein after the determining to control the drive assembly to drive the cleaning member to move relative to the lens body for cleaning the lens body, the method further comprises:
when the contamination detection assembly detects that the contamination still exists on the surface of the lens body, controlling the cleaning member to move relative to the lens body for a preset duration; and when the contamination still exists on the surface of the lens body, deactivating the lens body or controlling the lens body to stop outputting detection results, controlling the cleaning member to reset, and controlling the lawn mower to continue working.

14. The lens cleaning method according to claim 12, wherein after the deactivating the lens body, the method further comprises:
generating prompt information to prompt a user that the contamination detection assembly of the lawn mower is abnormal or the cleaning member is not capable of completing automatic cleaning of the lens body.

15. The lens cleaning method according to claim 4, wherein when controlling the cleaning member to move relative to the lens body for cleaning the lens body, the method comprises:
when the lawn mower needs to perform obstacle avoidance, performing an obstacle avoidance task synchronously during the controlling of the cleaning member to move relative to the lens body.

16. The lens cleaning method according to claim 11, wherein when controlling the cleaning member to move relative to the lens body for cleaning the lens body, the method comprises:
when the lawn mower needs to perform obstacle avoidance, performing an obstacle avoidance task synchronously during the controlling of the cleaning member to move relative to the lens body.

17. The lens cleaning method according to claim 4, wherein when controlling the cleaning member to move relative to the lens body for cleaning the lens body, the method comprises:
controlling the cleaning member to move relative to the lens body for a preset number of times at a preset cleaning cycle;
the preset cleaning cycle comprises an operation time period and a stop time period, the stop time period is set according to a preset duration, and the operation time period is shorter than the stop time period.

18. The lens cleaning method according to claim 11, wherein when controlling the cleaning member to move relative to the lens body for cleaning the lens body, the method comprises:
controlling the cleaning member to move relative to the lens body for a preset number of times at a preset cleaning cycle;
the preset cleaning cycle comprises an operation time period and a stop time period, the stop time period is set according to a preset duration, and the operation time period is shorter than the stop time period.

19. The lens cleaning method according to claim 4, wherein the method further comprises:
during the moving of the cleaning member relative to the lens body, deactivating the lens body or controlling the lens body to stop outputting detection results.
